(19) United States
(12) Patent Application Publication
(10) Pub. No.: US 2026/0288777 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/567,493

(22) Filed: Mar. 16, 2026

(30) Foreign Application Priority Data
Mar. 19, 2025 (JP) 2025-045080

(51) Int. Cl. G06F 16/332; G06F 16/334; G06F 16/335

(52) U.S. Cl. CPC G06F 16/3326; G06F 16/3344; G06F 16/337

(57) ABSTRACT

A system includes a processor that is configured to analyze contract information input by a user and generate a prompt for instructing generation of an appropriate contract document based on an analysis result of the contract information, output a generated contract document in a document file format and display the generated contract document via a user interface so that the user can review and edit the generated contract document, and analyze an emotion of the user by using an emotion analysis algorithm to analyze input information of the user and adjust wording of the contract document based on the emotion of the user.

### CROSS-REFERENCE TO RELATED APPLICATION

This application is based on and claims priority under 35 USC 119 from Japanese Patent Application No. 2025-045080 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional contract generation and approval support systems primarily focus on static template filling and simple workflow routing, and therefore fail to flexibly reflect nuanced user intent and emotional state in the generated contract documents or in the associated approval-follow-up operations. As a result, a sales representative or other user must repeatedly revise automatically generated drafts in order to align tone, strictness, or conciliatory language with the context of the negotiation, which increases time and burden. In addition, known systems do not adapt the frequency or method of follow-up of internal approval applications to a user's stress level, urgency perception, or engagement, thereby causing either excessive notifications or insufficient follow-up. Consequently, there is a need for a system capable of generating appropriate prompts for contract document generation, outputting contract documents in an editable form for the user, and dynamically adjusting both the document wording and the approval follow-up behavior in accordance with an analysis of the user's emotion.

### SUMMARY

In order to solve the foregoing problems, an embodiment of the invention provides a system comprising a processor, wherein the processor is configured to analyze contract information input by a user and generate a prompt for instructing generation of an appropriate contract document based on an analysis result of the contract information, and to output a generated contract document in a document file format and display the generated contract document via a user interface so that the user can review and edit the generated contract document. The processor is further configured to analyze an emotion of the user by using an emotion analysis algorithm to analyze input information of the user and to adjust wording of the contract document based on the emotion of the user. In certain embodiments, the processor is configured to generate a prompt for instructing, by using a generative AI model, generation of a document relating to a contract formation portion including at least one of a non-disclosure agreement and a basic resale agreement. In further embodiments, the processor is configured to generate a prompt for instructing dynamic adjustment, based on an analysis result obtained from an emotion analysis unit and according to the emotion of the user, of at least one of a frequency and a method of follow-up of an approval application.

The term “processor” refers to any hardware, firmware, or combination of hardware and software components capable of executing instructions, including but not limited to a central processing unit (CPU), graphics processing unit (GPU), microcontroller, or distributed processing circuitry configured to perform the claimed functions.

The term “contract information” refers to information related to a contract provided by a user, including but not limited to party names, contract type, effective date, term, territory, pricing, obligations, rights, and any other parameters or conditions used for generating a contract document.

The term “prompt” refers to data, a command, a query, or a structured instruction sequence supplied to a generative AI model or other document generation engine, which specifies how a contract document is to be generated, including desired content, format, tone, and constraints.

The term “contract document” refers to a document that defines rights and obligations between parties, including but not limited to a non-disclosure agreement, a basic resale agreement, and other agreements or contractual instruments generated or processed by the system.

The term “document file format” refers to a digital file format in which a contract document is stored or output, including but not limited to word processing formats such as DOC, DOCX, or RTF, and formats readable, savable, or editable by standard office applications. The term “user interface” refers to any interface through which a user interacts with the system, including but not limited to graphical user interfaces, web-based interfaces, mobile application interfaces, or command line interfaces that enable display of and interaction with contract documents.

The term “emotion analysis algorithm” refers to software, models, or processing logic that analyze user-related input information, such as text, voice, behavioral patterns, or other signals, to estimate or classify an emotional state of the user, including but not limited to stress, satisfaction, urgency, or hesitancy.

The term “emotion analysis unit” refers to a functional component implemented by hardware, software, or a combination thereof, that executes an emotion analysis algorithm to produce an analysis result representing a user's emotional state.

The term “generative AI model” refers to a machine learning model, such as a large language model or other generative model, trained to produce natural language text or document content in response to a prompt, and used for generating at least part of a contract document.

The term “contract formation portion” refers to one or more sections of a contract that define essential terms and conditions related to formation of the contractual relationship, including but not limited to parties, subject matter, confidentiality provisions, reseller terms, pricing, and other core clauses.

The term “non-disclosure agreement” refers to a contract document or contract type in which parties agree to obligations regarding protection, non-disclosure, and limited use of confidential information.

The term “basic resale agreement” refers to a contract document or contract type defining basic terms under which a reseller purchases, markets, or sells products or services, including but not limited to territory, pricing, commission, and responsibilities.

The term “approval application” refers to a request or process by which internal approval, authorization, or sign-off for a contract document is sought from one or more approvers or decision-makers within an organization.

The term “follow-up of an approval application” refers to any operation performed to track, remind, notify, or otherwise prompt progress of an approval application, including sending notifications, updating status, or escalating pending approvals.

The term “frequency of follow-up” refers to how often follow-up operations related to an approval application are performed within a specified time period.

The term “method of follow-up” refers to the manner, channel, or style in which follow-up operations are carried out, including but not limited to email reminders, in-application notifications, messaging system alerts, or changes in tone or content of such reminders.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

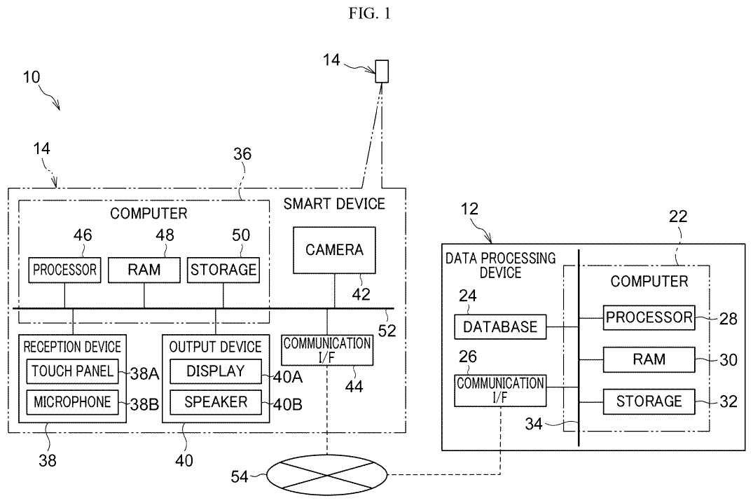

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

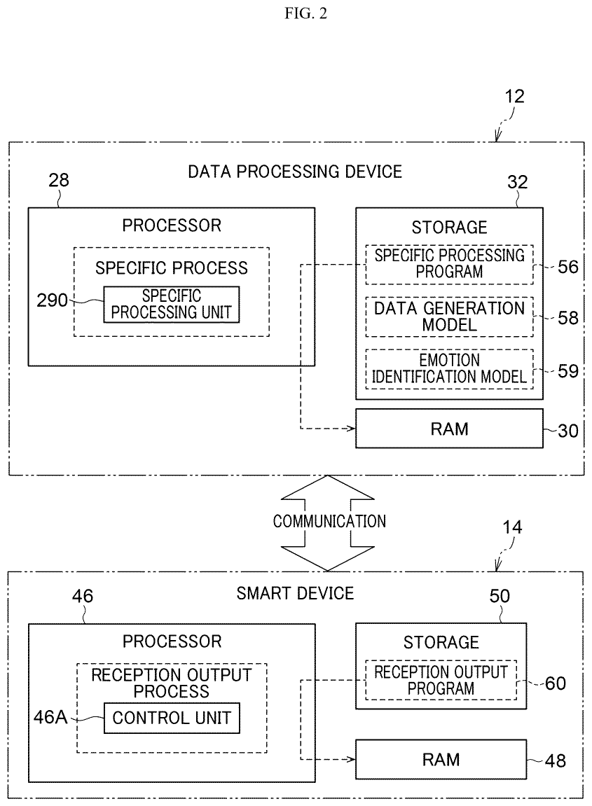

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional contract creation systems typically rely on fixed templates and rule-based text assembly executed by general-purpose processors. In such systems, a processor receives contract information, selects a pre-defined template, and performs straightforward text substitution. This approach has several technical limitations in terms of computer technology.

First, when large volumes of heterogeneous contract information are accumulated, conventional systems impose a high computational load on search and retrieval components. Index structures and storage layouts are not optimized around dynamically generated document content, so the processor must frequently perform repeated, inefficient scans of document repositories and metadata tables. This leads to increased latency in retrieving relevant past contracts and clauses, which degrades the responsiveness of the system and the efficiency of processor and storage resources.

Second, conventional systems do not tightly couple the generation of contract text by a generative AI model with downstream document structuring, file-format conversion, and indexing. Typical usage treats the generative AI output as unstructured text that is manually copied into word-processing files by a user. As a result, the processor does not systematically transform the AI output into a structured document representation aligned with an office document format, and does not automatically register metadata and index information. This causes inefficient file operations, fragmented storage, and additional processing overhead for subsequent searches and revisions.

Third, user interaction in conventional systems is largely static and does not leverage emotion analysis. User input is handled as plain text or form entries with no adaptive adjustment of prompts, tone, or follow-up operations. The processor therefore cannot dynamically optimize the behavior of the generative AI model or the notification and follow-up mechanisms based on the user's mental state. This leads to inefficient use of computational resources for repeated or inappropriate follow-up operations, and increases the number of interactions and re-generations required to reach an acceptable contract draft.

Fourth, conventional systems lack an integrated loop in which the processor acquires additional prompt sentences or correction instructions, reuses existing structured contract data, and selectively updates only specific clauses via a generative AI model. In typical implementations, any modification request leads to full re-generation of an entire document or manual editing by the user, which consumes unnecessary processor cycles, increases memory transfers, and complicates version management of document data and indexes. Accordingly, there is a need for improved computer-implemented techniques in a contract document generation system, in which a processor (i) analyzes contract information from a user terminal, (ii) constructs and refines prompt sentences for a generative AI model, (iii) systematically transforms AI-generated text into structured electronic document data in a predetermined file format, (iv) automatically stores and indexes such data to reduce the computational load of information retrieval, and (v) adaptively adjusts prompts, document wording, and follow-up operations based on emotion analysis of user input. Such techniques can improve the overall performance, scalability, responsiveness, and resource utilization of contract generation and management in a computer system.

The specific processing by the specific processing unit 290 of the data processing device 12 in Example 1 is realized by the following means.

The present invention provides a server comprising a processor configured to analyze contract information acquired from a user terminal and extract purpose information, party information, period information, and contract type information; to construct a prompt sentence instructing a generative AI model to generate a contract document draft based on the extracted contract information, and to provide input data including the prompt sentence and the contract information to the generative AI model; to post-process text data output from the generative AI model and convert the text data into document structure data to which heading information, clause information, and format information are assigned; to generate, based on the document structure data, electronic document data conforming to a predetermined document file format, to store the electronic document data in a storage device, and to register contract information and metadata associated with the electronic document data as search information in an index database; to transmit the electronic document data to the user terminal via a user interface so that the electronic document data is displayable and editable at the user terminal; to acquire, from the user terminal, an additional prompt sentence or a correction instruction, to re-input the additional prompt sentence and at least part of the electronic document data into the generative AI model to obtain an updated contract document draft in which a specific clause is modified, and to update the electronic document data based on the updated contract document draft; to acquire, from the user terminal, a search condition relating to past contract information, to search the index database using the search condition to extract related contract document information, and to provide a result of the extraction to the user terminal to reduce a load of information retrieval; and to execute emotion analysis processing on user input information to calculate emotion information and to adjust at least one of tone, expression strength, and follow-up operation condition of the prompt sentence or the contract document draft based on the emotion information. This enables a computer system to generate, manage, and retrieve contract documents with reduced computational load and improved responsiveness by tightly integrating generative AI model invocation, structured document formation, storage and indexing operations, iterative prompt-based refinement, and emotion-adaptive interaction within a unified processor-controlled workflow.

The term “system” refers to an arrangement including at least one server, at least one processor, at least one storage device, and at least one communication interface configured to perform the claimed processing in cooperation with at least one user terminal.

The term “server” refers to an electronic apparatus including a processor, a memory, and a communication interface, configured to communicate with a user terminal over a network and to execute programs that implement contract-related processing described in the claims.

The term “processor” refers to one or more hardware processing units, such as a central processing unit or a graphics processing unit, capable of executing instructions stored in a memory to perform analysis, generation, conversion, storage, retrieval, and communication operations.

The term “user terminal” refers to an information processing device operated by a user, such as a personal computer, a tablet device, or a mobile communication device, configured to input information, display data, and communicate with the server.

The term “contract information” refers to data related to a contract to be generated or managed, including at least purpose information, party information, period information, and contract type information, and optionally additional parameters or instructions.

The term “purpose information” refers to data describing an objective, use case, or business purpose of a contract, such as protecting confidential information or defining terms of a transaction.

The term “party information” refers to data identifying contracting entities, including at least names or identifiers of organizations or individuals that are parties to a contract.

The term “period information” refers to data specifying temporal conditions of a contract, such as an effective date, an expiration date, or a duration.

The term “contract type information” refers to data indicating a category or class of contract, such as a confidentiality contract, a sales transaction contract, or a use license contract.

The term “prompt sentence” refers to an instruction text or set of instruction texts configured to direct a generative AI model to perform a specific generation task, including generation or modification of contract document content.

The term “generative AI model” refers to a machine-learned model, such as a neural network-based language model, configured to generate text data in response to an input including a prompt sentence and associated contract information.

The term “contract document draft” refers to contract-related text data generated by the generative AI model based on input data, before or after post-processing and before finalization by a user.

The term “text data” refers to machine-readable character data output from the generative AI model, representing natural language sentences and clauses of a contract.

The term “post-process” refers to processing that modifies or augments text data output from the generative AI model, including at least segmentation, insertion of headings, numbering, normalization of expressions, and formatting-related adjustments.

The term “document structure data” refers to structured data representing a logical structure of a document, including heading information, clause information, and format information that can be mapped to a document file format.

The term “heading information” refers to data indicating titles or section headings of a contract document and their hierarchical relationships.

The term “clause information” refers to data indicating individual contract clauses or sections, and their positions or relationships within the document.

The term “format information” refers to data specifying document layout or style, including at least font attributes, paragraph styles, numbering schemes, and page layout settings.

The term “electronic document data” refers to data representing a contract document in a predetermined document file format, suitable for storage, transmission, display, and editing by document processing software.

The term “predetermined document file format” refers to a standardized electronic file format, such as an office document format, that defines a structure for representing text, styles, and layout in a machine-readable file.

The term “storage device” refers to a non-transitory computer-readable medium, such as a magnetic storage device, a solid-state storage device, or a network-accessible storage service, configured to store data including electronic document data and contract information.

The term “file storage device” refers to a storage device or storage system configured to store files as units of data, including electronic document data in the predetermined document file format.

The term “metadata” refers to data describing attributes of contract information or electronic document data, such as identifiers, dates, contract type, parties, and summary information.

The term “index database” refers to a data management system configured to store index entries derived from contract information and metadata, and to support efficient search and retrieval operations based on search conditions.

The term “search information” refers to data stored in the index database, including index keys and associated references to contract information or electronic document data, used for retrieval processing.

The term “user interface” refers to a logical interface, such as a graphical or programmatic interface, through which the user terminal exchanges information with the server, including at least input of contract information and display or editing of electronic document data.

The term “additional prompt sentence” refers to a prompt sentence received after an initial contract document draft is generated, the additional prompt sentence instructing the generative AI model to revise, extend, or otherwise modify contract content.

The term “correction instruction” refers to information input by a user specifying a modification to existing contract content, such as changing a clause, adding a clause, or simplifying language.

The term “updated contract document draft” refers to contract text generated by the generative AI model in response to an additional prompt sentence or a correction instruction and intended to replace or modify at least a part of a prior contract document draft.

The term “specific clause” refers to an identified portion of a contract document draft, such as a particular section, article, or paragraph, targeted for modification or generation.

The term “search condition” refers to one or more parameters, such as a keyword, a contract type, a date range, or a party name, used by the server to search the index database for related contract document information.

The term “contract document information” refers to information related to a contract document retrievable from the index database, including at least identifiers, metadata, and links to corresponding electronic document data.

The term “information retrieval” refers to processing for locating, accessing, and returning contract document information or electronic document data from the index database and storage device based on a search condition.

The term “emotion analysis processing” refers to computational processing that analyzes user input information, such as text or interaction patterns, to estimate an emotional state or attitude of the user.

The term “emotion information” refers to data representing an estimated emotional state of the user, such as levels of stress, urgency, satisfaction, or frustration, used to control subsequent processing.

The term “tone” refers to stylistic characteristics of a textual expression, including formality, politeness, directness, and level of emphasis used in a prompt sentence or contract document draft.

The term “expression strength” refers to a degree of intensity or assertiveness of wording in a prompt sentence or contract document draft.

The term “follow-up operation condition” refers to parameters controlling behavior of follow-up processing, including at least notification frequency, notification method, and content of follow-up messages associated with approval requests or contract-related tasks.

The term “approval request” refers to a request for authorization or decision concerning a contract or related process, sent to a reviewer, approver, or decision-maker within a workflow.

The term “progress management operation” refers to processing that tracks, updates, and notifies about a status of an approval request or contract-related workflow step.

The term “follow-up message” refers to a message generated at least in part by the generative AI model, configured to prompt a user or approver regarding an approval request or related task in accordance with follow-up operation conditions.

In one embodiment, a server executes a contract document generation and management program stored in a non-transitory computer-readable medium. The server includes at least one processor, a main memory, a storage device, and a network interface. The server communicates with at least one terminal operated by a user via a communication network.

The terminal executes a web browser or a native application on an operating system such as a general-purpose desktop operating system or a mobile operating system. The terminal displays input forms and contract document previews to the user. The terminal sends contract information and prompt sentences to the server using a secure communication protocol such as HTTPS, and receives electronic document data in a predetermined document file format from the server.

The server executes a web application implemented by a framework such as a general-purpose web application framework. The server also executes a back-end application implemented in a general-purpose programming language, a database management system such as a relational database system, a search engine such as a full-text search engine, and a document generation library that supports an office document format. These concrete software components are examples, and the invention is not limited to particular commercial products.

The server stores, in the storage device, a plurality of modules including a contract information analysis module, a prompt construction module, a generative AI interface module, a post-processing and structuring module, a document file generation module, an indexing and search module, and an emotion analysis module. The processor loads these modules into the memory and executes them to perform the functions defined in the claims. The server, in response to input from the terminal, stores contract information in a structured internal representation. For example, the server represents contract information as a record having fields such as purpose, parties, period, jurisdiction, contract type, and free-form conditions. Each field is stored in a normalized form in a relational table, and the server assigns a unique contract identifier. By maintaining this independent data structure, the server can precisely control which parts of the information are used for generative processing and which parts are used only for indexing or search.

The server constructs a prompt sentence for a generative AI model by programmatically combining templates with the structured contract information. The server does not simply transmit the raw user input as-is; instead, the server uses a deterministic algorithm to embed the purpose information, party information, period information, and contract type information into a multi-part prompt sentence. For example, the server can generate a prompt sentence such as:
“You are a contract drafting assistant. Generate a draft non-disclosure agreement with the following attributes: Purpose: protection of confidential technical and business information. Parties: Disclosing Party and Receiving Party. Term: 3 years from the effective date. Governing law: applicable jurisdiction. Include detailed confidentiality obligations, permitted disclosures, and survival of confidentiality obligations after termination.”

The server can alternatively generate other prompt sentences such as:
“Generate the confidentiality section of an NDA between a disclosing entity and a receiving entity, effective for three years from the effective date. Focus on definition of confidential information, obligations of receiving entity, and exceptions.”
“Create a termination clause for a software license agreement that requires 30 days' written notice for termination for convenience and immediate termination in case of material breach.”
“Rewrite the indemnification clause in simpler language suitable for a small business customer while maintaining legal effect.”
“Add a data protection clause that complies with data protection regulations and limits cross-border transfers of personal data.”

The server transmits the constructed prompt sentence and the structured contract information to a generative AI model. The generative AI model, in one embodiment, is a transformer-based neural network language model executed on a computing platform including a CPU and optionally a GPU. The model consists of an embedding layer that converts tokens into dense vectors, a plurality of self-attention layers, feed-forward layers, and an output layer that maps internal representations to probability distributions over vocabulary tokens.

The server stores, in the storage device, learned parameters of the generative AI model, including weight matrices for attention, projection, and feed-forward operations. The server loads these parameters into memory at inference time. The server performs neural network inference by repeatedly applying matrix multiplications, nonlinear activation functions, and softmax operations to compute the probability distribution of the next token given previous tokens. The server selects each output token according to a decoding algorithm such as greedy decoding, beam search, or nucleus sampling, with parameters such as temperature and top-p specified. By explicitly controlling these parameters, the server can adjust the balance between determinism and diversity of generated clauses.

The server, in one embodiment, uses a model that has been fine-tuned using supervised learning and optionally reinforcement learning from human feedback. During training, the model receives pairs of input prompts and target contract clauses, and the server minimizes a loss function such as cross-entropy between predicted tokens and target tokens. The training process updates weight parameters using an optimization algorithm such as stochastic gradient descent or Adam. The server may also apply data augmentation techniques such as paraphrasing, clause order variation, and insertion of synthetic edge cases to improve robustness of the model to unusual contract conditions.

The server, when executing inference, does not re-train the model but uses the pre-trained parameters to produce outputs with low latency. Because the generative AI model internally learns representation of complex legal and linguistic patterns that cannot be feasibly encoded as static rules, the server can generate contract clauses that flexibly adapt to a wide range of input conditions while maintaining high syntactic and semantic consistency.

The server receives the sequence of tokens output by the generative AI model and reconstructs text data. The server then performs post-processing that is specific to contract documents. The server segments the text data into sections by detecting patterns such as numbering “1.”, “1.1”, or line headings in uppercase. The server maps each detected section into a clause data structure having attributes such as heading, body text, clause type, and sequence position.

The server associates clause types with semantic labels, for example, confidentiality, term, termination, governing law, dispute resolution, or data protection. The server determines clause type by applying pattern-matching rules and optionally a secondary classifier such as a lightweight neural network or a decision tree trained on clause samples. This classification enables the server to selectively update only a target clause when a later prompt sentence refers to “the limitation of liability clause” or “the termination clause,” instead of regenerating the entire document.

The server converts the structured clause data into document structure data that reflects a hierarchical outline. The document structure data includes document-level attributes, a list of sections and subsections, and their styles. The server assigns specific styles that correspond to an office document format, such as title style for the main title and heading styles for different levels. By performing this mapping at the server side, the server can ensure that every generated document conforms to a consistent structure, which improves downstream processing such as comparison, version control, and automatic extraction.

The server invokes a document generation library compatible with office document formats. The server creates an in-memory document object, inserts paragraphs corresponding to each clause, and applies formatting attributes such as font family, size, alignment, indentation, and spacing. The server also inserts structural elements such as page breaks, numbering lists, tables for party information, and signature blocks. Because the server constructs the document programmatically from the document structure data, the resulting electronic document data is free from formatting anomalies that typically occur in manual editing, and the file is directly usable by standard office software without additional human adjustment. The server stores the generated electronic document data as a file in the storage device and registers a reference to the file in the relational database, linked with the contract identifier and metadata such as contract type, parties, period, and generation timestamp. The server extracts a plain-text representation of the document and registers it in a search index managed by a search engine. The index stores inverted lists of terms, as well as field-specific indices for party names, dates, and clause types. This structure allows the server to answer complex queries such as “all NDAs with term longer than two years involving a particular party” using range queries and combined filters, thereby reducing the number of disk accesses and CPU cycles compared with naive string search over entire documents.

The server, when the user later requests a search from the terminal, uses the index to retrieve candidate contract identifiers in logarithmic or sub-linear time relative to the total number of contracts. The server then fetches only the relevant metadata and document references, significantly reducing storage I/O and network traffic. This specific indexing and retrieval architecture improves the scalability of the system when the number of stored contracts grows, and constitutes an improvement to computer data management and search technology. The server provides, via the user interface, the generated electronic document data to the terminal. The terminal receives a file in the office document format and either launches a local document editor or displays a preview. The user reads and edits the document using the editor's interface. When the user identifies a clause that needs modification, the user can input an additional prompt sentence into a dedicated field, such as “Please soften the liability limitation clause” or “Add a clause dealing with data protection under GDPR.” The terminal transmits this additional prompt sentence and context information, such as the contract identifier and the targeted clause text, to the server.

The server, upon receiving the additional prompt sentence, selects the corresponding clause data structure using the clause type labels and positions. The server constructs a new prompt sentence that includes the current clause text and the user's modification instruction, for example:
“Here is the current limitation of liability clause: [clause text]. Rewrite this clause in a more user-friendly tone while maintaining the legal effect. Avoid overly technical jargon and keep sentence length moderate.”

The server transmits this new prompt sentence to the generative AI model, and the model generates a revised clause. The server then replaces only the targeted clause in the document structure data with the revised clause, and regenerates the electronic document data. Because the server updates only the modified sections instead of re-generating the entire document, the server reduces computation time and network bandwidth usage, and the system can respond more quickly. This selective regeneration is a non-conventional processing pattern that leverages the internal clause indexing, and provides a technical improvement over conventional full-document re-generation workflows.

The server additionally executes emotion analysis processing on user input information. The server uses a separate machine learning model, such as a recurrent neural network or transformer-based classifier, trained on text labeled with emotion categories (e.g., calm, urgent, frustrated, satisfied). The emotion analysis model receives as input the text of messages, comments, or prompt sentences entered by the user. The server converts the text into token sequences, applies embedding and attention or recurrent operations, and outputs probabilities for each emotion category. The server stores resulting emotion information as a feature vector associated with the current session or contract.

The server uses the emotion information to adjust attributes of subsequent prompt sentences and follow-up operations. For example, when the emotion analysis indicates high frustration or urgency, the server modifies the prompt sentence to generate contract text with a more concise and direct tone, and simultaneously reduces the frequency of non-essential follow-up notifications to avoid overloading the user. When the emotion analysis indicates low engagement, the server modifies the follow-up messages to be more detailed or explanatory, and may increase the notification frequency within a defined limit.

Because the server calculates emotion information and directly uses it to control parameters of prompt construction, text generation style, and notification scheduling algorithms, the system achieves an adaptive behavior that is not achievable by fixed rule-based scripts. This adaptation reduces unnecessary communications, lowers processing load for repeated or redundant tasks, and results in an improved user interaction loop that is sensitive to computational constraints and human factors.

The server, by centralizing control of contract analysis, prompt construction, generative inference, structured document assembly, storage, indexing, search, and emotion-adaptive interaction, implements a coordinated workflow that improves multiple aspects of computer operation. The server reduces end-to-end latency of contract generation by pre-structuring contract information and by using targeted clause updates. The server improves precision of search results and reduces I/O overhead by maintaining a document structure-aware index. The server enhances reliability and consistency of documents by mapping generative outputs through a deterministic document structure model and style templates, thus avoiding inconsistent formatting. The server lowers communication and processing overhead by adjusting follow-up operations based on emotion analysis, thereby reducing redundant interactions.

The terminal, in all embodiments, remains relatively simple and primarily handles user input and document display. The computationally intensive operations, such as generative inference, indexing, and emotion analysis, are offloaded to the server, where hardware resources and optimization strategies can be centrally managed. This architecture enables scaling to multiple users and large volumes of contracts while maintaining predictable performance.

In another embodiment, the server executes the generative AI model locally on dedicated hardware accelerators, such as graphics processing units or tensor processing units. The server schedules inference tasks across multiple devices, using batching and caching techniques to reuse computations for similar prompts. This configuration further reduces response time for repeated contract types and improves utilization of hardware resources. In yet another embodiment, the server can select between multiple generative AI models depending on contract type or clause type. For example, the server can use one model fine-tuned for confidentiality clauses and another model fine-tuned for indemnification clauses. The server records performance metrics such as generation time and clause acceptance rate, and updates its model selection policy accordingly. This dynamic model selection allows the server to further optimize computational efficiency and output quality.

By applying these computer-implemented structures and algorithms, the system does not merely automate human drafting tasks, but improves the underlying computer technology used to generate, structure, store, and retrieve contract documents. The combination of fine-grained contract information analysis, structured prompt sentence construction, transformer-based generative AI inference, clause-level document structuring, efficient indexing, selective clause regeneration, and emotion-aware control of interaction parameters yields concrete technical effects such as faster processing, reduced error rates, lower storage and communication loads, and more efficient utilization of processor and memory resources.

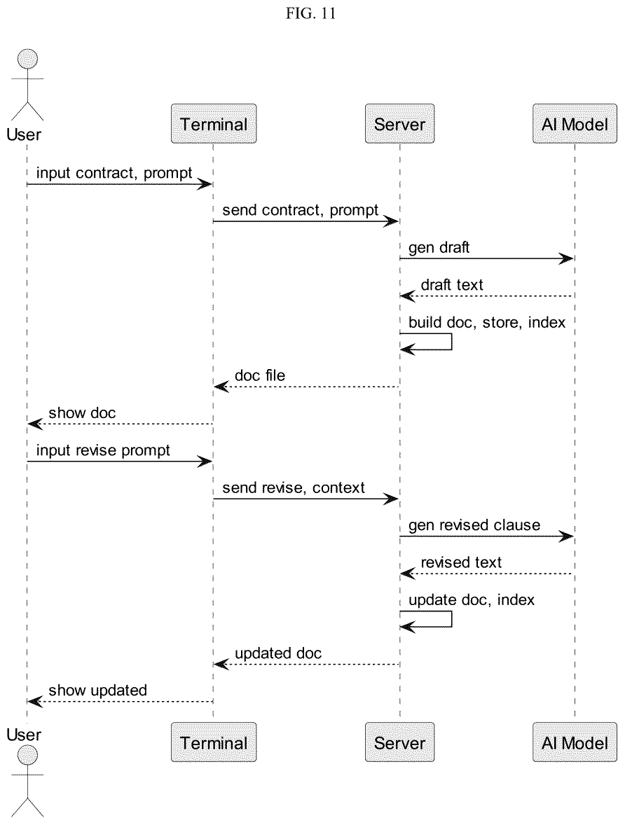

The following describes the processing flow using FIG. 11.

### Step 1:

The terminal displays an input interface and acquires contract information from the user.

The terminal presents input fields for purpose information, party information, period information, contract type information, and a free-text field for a prompt sentence.

Input: keystrokes, touch or mouse input from the user.

Processing: the terminal stores each entered value in an internal data structure (for example, a key-value map) and performs local validation such as checking that mandatory fields are not empty and that dates follow a valid format.

Output: a structured request payload including the contract information and the prompt sentence, ready to be sent to the server.

### Step 2:

The terminal transmits the structured request to the server.

The terminal serializes the contract information and the prompt sentence into a message format such as JSON and sends an HTTPS request to a predefined API endpoint on the server.

Input: the internal data structure holding the contract information and the prompt sentence.

Processing: the terminal applies a serialization procedure, encrypts the data via a transport layer security stack, and attaches authentication data such as a session token.

Output: an encrypted network message containing the serialized request, delivered to the server.

### Step 3:

The server receives and parses the incoming request.

The server accepts the HTTPS connection, decrypts the payload, and passes the message body to an application handler.

Input: the serialized JSON or similar representation of contract information and the prompt sentence.

Processing: the server parses the message, validates field formats, and converts the message into typed objects (for example, a ContractInfo object and a PromptInstruction object). The server checks constraints such as allowed contract types and valid date ranges.

Output: validated in-memory objects representing the contract information and the initial prompt sentence.

### Step 4:

The server stores the contract information and associates a contract identifier.

The server writes the contract information into a relational database and creates a new record.

Input: the ContractInfo object containing purpose, parties, period, contract type, and other parameters.

Processing: the server generates a unique identifier, constructs SQL INSERT statements, and commits the transaction. The server may normalize party names and map contract types to internal enumeration codes.

Output: a persistent database entry for the contract and a contract identifier returned to the application layer.

### Step 5:

The server constructs a model-ready prompt sentence.

The server combines a template, the contract information, and the user's original prompt sentence to form a refined prompt sentence suitable for the generative AI model.

Input: the PromptInstruction object, the ContractInfo object, and optional system-level templates.

Processing: the server replaces placeholder tokens in the template (for example, {PURPOSE}, {PARTIES}, {TERM}, {TYPE}) with corresponding fields from the ContractInfo object, and appends or prepends the user's own instructions. The server ensures that the resulting text does not exceed a defined length and normalizes terminology.

Output: a consolidated prompt sentence string that explicitly encodes the contract attributes and the generation intent.

### Step 6:

The server prepares the generative AI model input.

The server transforms the prompt sentence and relevant contract attributes into the format required by the generative AI model.

Input: the consolidated prompt sentence string and selected fields of the contract information.

Processing: the server applies tokenization, converts tokens to numerical identifiers using a vocabulary table, and assembles a sequence or a set of message objects (for example, “system”, “user” roles) as required by the model API. The server also sets inference parameters such as maximum token length, temperature, and top-p values.

Output: a model input structure comprising token sequences and inference parameters.

### Step 7:

The server executes inference using the generative AI model.

The server feeds the model input structure to a transformer-based neural network running on a processor and optionally a hardware accelerator.

Input: the tokenized prompt and the configuration parameters for decoding.

Processing: the server performs a series of matrix multiplications, attention computations, and non-linear activations across multiple layers of the model. At each step, the server computes probability distributions over output tokens and selects the next token according to the configured decoding algorithm. This process iterates until an end-of-sequence condition is met or a maximum length is reached.

Output: an ordered sequence of output tokens representing the generated contract document draft.

### Step 8:

The server reconstructs text data from the model output.

The server converts the output token sequence into a human-readable text string.

Input: the list of output token identifiers generated by the generative AI model.

Processing: the server applies a detokenization procedure using the same vocabulary table, concatenates tokens into text, and normalizes spacing and punctuation. The server checks for incomplete sentences at the end and optionally trims or supplements them using rule-based logic.

Output: a continuous text string representing the generated contract document draft.

### Step 9:

The server segments and classifies clauses in the generated text.

The server identifies boundaries between clauses and assigns clause types.

Input: the generated contract text string.

Processing: the server scans the text for patterns such as numbering, headings, and keyword cues. The server splits the text at these boundaries to form clause units and applies pattern-matching rules or a lightweight classifier to label each clause as, for example, confidentiality, term, termination, governing law, or miscellaneous.

Output: a list of clause objects, each containing a heading, body text, position index, and a clause type label.

### Step 10:

The server builds document structure data.

The server constructs a hierarchical representation of the contract document suitable for mapping to an office document format.

Input: the list of clause objects and document-level attributes such as title and parties.

Processing: the server defines a document root, assigns a title node, and organizes clauses into sections and subsections. The server attaches formatting attributes, such as which style to use for each level of heading and which numbering scheme to apply.

Output: document structure data representing the logical organization of the contract.

### Step 11:

The server generates an electronic document file.

The server creates a document in a predetermined office document format (for example, a word-processing format) using a document-generation library.

Input: the document structure data including headings, clauses, and formatting attributes.

Processing: the server instantiates an in-memory document object, inserts paragraphs for each node in the structure, sets fonts, sizes, margins, and paragraph styles, and adds page breaks and signature areas as needed. The server then serializes the document object into a binary file conforming to the office document specification.

Output: electronic document data in the predetermined document file format.

### Step 12:

The server stores and indexes the electronic document data.

The server persists the generated file and creates search indices for efficient retrieval.

Input: the electronic document data, the contract identifier, and associated metadata such as contract type, parties, and dates.

Processing: the server writes the file to a storage device and records the file path or object key in the relational database. The server extracts a plain-text version of the document, builds index entries (for example, term-contract mappings, field-specific indices), and writes these entries into an index database managed by a search engine.

Output: a stored document file with a database reference and an updated search index entry linked to the contract identifier.

### Step 13:

The server transmits the electronic document to the terminal.

The server prepares a response message containing the generated document.

Input: the file path or object key for the stored document and the identifier of the requesting user session.

Processing: the server reads the file from storage, sets appropriate response headers indicating the file type and filename, and sends the file content through an HTTPS response to the terminal. The server may also log the transaction with timestamps and identifiers.

Output: a network response message carrying the electronic document data to the terminal.

### Step 14:

The terminal receives, stores, and opens the electronic document.

The terminal processes the incoming response and makes the document available to the user.

Input: the HTTPS response containing the electronic document data.

Processing: the terminal saves the file to local storage or a temporary location, invokes a word-processing application or a built-in viewer, and passes the file path to that application. The terminal updates its user interface to show the newly generated contract document to the user.

Output: a displayed contract document that the user can read and edit.

### Step 15:

The user reviews the document and specifies modifications.

The user inspects the generated clauses and identifies any parts that need adjustment.

Input: the displayed contract document in the word-processing application.

Processing: the user reads the text, compares it with the intended contract conditions, and decides on changes. The user may type an additional prompt sentence such as “Please simplify the limitation of liability clause” or “Add a clause dealing with data protection under GDPR” into a dedicated input field in the terminal application.

Output: a new modification instruction and an additional prompt sentence entered into the terminal.

### Step 16:

The terminal sends modification instructions and context to the server.

The terminal bundles the additional prompt sentence with context data.

Input: the additional prompt sentence provided by the user and contextual information such as the contract identifier and, optionally, the text of the target clause.

Processing: the terminal creates a new JSON payload that includes the contract identifier, the additional prompt sentence, and metadata about the selected clause or document section. The terminal sends this payload to the server via HTTPS.

Output: an encrypted network message containing modification instructions and context.

### Step 17:

The server selects the target clause and constructs an update prompt.

The server determines which clause should be modified and prepares a tailored prompt sentence for the generative AI model.

Input: the contract identifier, the additional prompt sentence, and clause selection information sent from the terminal.

Processing: the server retrieves the relevant document structure data and clause list from the database or cache, locates the clause whose identifier or type matches the context, and extracts its text. The server then constructs a new prompt sentence that embeds both the existing clause text and the requested modification, ensuring that the model is constrained to revise only the specified content.

Output: an update-oriented prompt sentence and the corresponding clause context for the generative AI model.

### Step 18:

The server performs clause-level regeneration using the generative AI model.

The server feeds the update-oriented prompt and clause context into the generative AI model to obtain a revised clause.

Input: the update prompt sentence and the original clause text.

Processing: the server tokenizes the inputs, runs the transformer inference process, and generates a new token sequence representing the revised clause. The server then detokenizes the output and normalizes formatting.

Output: a revised clause text consistent with the user's modification instruction.

### Step 19:

The server updates the document structure and regenerates the electronic document.

The server integrates the revised clause into the existing document structure.

Input: the revised clause text and the current document structure data.

Processing: the server replaces the original clause body in the clause object with the revised text, leaving other clauses unchanged. The server then re-executes the document file generation process using the updated structure to create a new version of the electronic document data. The server stores the new file, updates the database reference, and refreshes the index entries for the affected clauses.

Output: an updated electronic document file reflecting the clause modification and updated index information.

### Step 20:

The server conducts emotion analysis on user input and adjusts behavior.

The server processes recent user inputs to estimate emotion and tune subsequent operations.

Input: user-entered text such as prompt sentences, comments, and feedback messages.

Processing: the server feeds the text through an emotion classification model, computes an emotion vector, and interprets values such as frustration or urgency levels. Based on these values, the server modifies parameters for prompt construction (for example, tone and length), adjusts notification frequency for follow-up messages, or selects more concise generation settings.

Output: adjusted system parameters that influence future prompt sentences, generative AI behavior, and follow-up communication patterns.

### Step 21:

The terminal receives updated documents and follow-up messages.

The terminal presents revised documents and system-generated messages to the user.

Input: updated electronic document files and follow-up messages sent by the server based on adjusted parameters.

Processing: the terminal downloads the new file version, opens or refreshes the document view, and displays follow-up messages in a notification area or message pane. The terminal thereby informs the user of changes and next recommended actions.

Output: an updated user interface that shows revised contract content and context-aware follow-up information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional contract generation and approval systems primarily rely on static templates and rule-based engines executed by general-purpose processors. In such systems, a processor typically merges user input into pre-defined text fragments and then outputs a document file. This architecture introduces several technical problems from the viewpoint of computer technology.

First, because user input is only weakly structured and often handled as free-form text, the processor must perform repeated parsing, validation, and template matching operations, leading to inefficient use of memory and processor cycles. As contract complexity increases, this causes higher CPU load, longer response times, and increased network traffic due to multiple round trips between a client device and a server for corrections and re-generation. Second, existing document-generation pipelines are not optimized for integration with generative AI models. Prompt construction is often ad hoc and performed in the client application, which results in redundant data transfers, duplicated preprocessing, and inconsistent prompt formats. This degrades the quality and stability of outputs from the generative AI model and requires additional post-processing on the client side, thereby increasing computational burden on heterogeneous terminal devices with limited resources. Third, current systems generally treat contract drafting, document formatting, and electronic signing as separate, loosely coupled subsystems. A processor may generate a draft on one service, convert it to an electronic document on another service, and apply an electronic signature through yet another service. This fragmented processing causes format conversions, repetitive hashing operations, and multiple storage and retrieval operations across disparate modules. Such fragmentation leads to latency, increased I/O operations, and difficulty in maintaining consistent version control of contract documents within storage.

Fourth, existing search and reuse functions for past contracts are usually implemented as simple text-based retrieval on static documents. The processor retrieves past files but does not integrate them into a structured prompt-generation pipeline for a generative AI model. As a result, the system cannot efficiently leverage previously stored contract data to generate new drafts, and must repeatedly perform full-text parsing and manual editing, which increases computation and I/O load and reduces scalability when the number of contracts grows. Fifth, emotion analysis in conventional systems, if present at all, is typically implemented as an auxiliary front-end feature and is not technically integrated into the document generation and notification logic executed by the processor. Therefore, the system cannot adapt internal processing parameters, such as prompt construction and notification generation, based on user emotional state. This leads to inefficient interaction patterns, redundant notifications, and additional processing loops when users hesitate or become dissatisfied, thereby increasing network traffic and processor workload.

Accordingly, there is a need for an improved computer-implemented system in which a processor centrally controls (i) structured acquisition of contract-related information, (ii) construction of prompt sentences for a generative AI model, (iii) generation and structural analysis of contract drafts, (iv) integrated document templating and electronic signing, (v) index-based search and reuse of contract management data, and (vi) adaptive processing based on user emotion analysis. Such a system should reduce redundant parsing and formatting operations, minimize bandwidth consumption between server and terminal, improve the efficiency and determinism of document generation, and provide a technically improved pipeline for contract lifecycle management on a computing platform.

The specific processing by the specific processing unit 290 of the data processing device 12 in Application Example 1 is realized by the following means.

The present invention provides a server comprising a processor configured to receive, via a user interface, contract-related information input by a user and generate structured data including the contract-related information; construct, within the server, a prompt sentence for a generative AI model based on the structured data; transmit a generation request including the prompt sentence to the generative AI model and obtain, from the generative AI model, natural language text as a draft of a contract document; analyze the natural language text to divide the natural language text into contract clause units and generate document structure data including headings and clause numbering; embed the document structure data into a predetermined document template to generate a contract document file in an electronic document format; present, via the user interface, at least one of the contract document file and the natural language text for review and editing by the user, accept an editing operation from the user, and reflect an editing result in the contract document file; accept, via the user interface, an electronic signature request for the contract document file, calculate a hash value of the contract document file by using a cryptographic algorithm, generate electronic signature data for the hash value by using a secret key, and embed the electronic signature data into the contract document file; store contract management data including the contract-related information and version information of the draft of the contract document in a storage, and index the contract management data so that past contract documents are searchable; receive, via the user interface, a search condition for the indexed contract management data, extract, based on the search condition, at least one past contract document as a search result, generate a new prompt sentence based on the at least one past contract document and the structured data, and cause the generative AI model to regenerate a new draft of a contract document based on the new prompt sentence; and apply an emotion analysis algorithm to input information from the user to estimate an emotional state of the user, and adjust at least one of the prompt sentence and the natural language text of the draft of the contract document according to the estimated emotional state. This enables an integrated, server-centered processing pipeline in which the processor systematically converts user input into structured data, generates stable and context-aware prompt sentences for the generative AI model, reduces redundant client-side processing, minimizes format conversions across subsystems, and efficiently manages generation, versioning, searching, reuse, and electronic signing of contract documents, thereby improving overall computational efficiency, responsiveness, and scalability of the computer-based contract management system.

The term “processor” refers to a hardware computation unit, such as a central processing unit or a combination of processing cores, configured to execute instructions of a program that implements the functions described in the claims.

The term “user interface” refers to a hardware and software interaction layer, including display, input devices, and associated control logic, through which a user provides information to, and receives information from, the system.

The term “contract-related information” refers to input data describing parameters of a legal agreement, including at least a type of agreement, identification of parties, commercial conditions, and applicable rules, which are used to generate a draft contract document.

The term “structured data” refers to data that has been organized into a predetermined format or schema, such as key-value pairs or records, enabling deterministic parsing and processing by the processor.

The term “prompt sentence” refers to a text-based instruction or set of instructions, generated by the processor, that directs a generative AI model to produce specific output content, including a draft of a contract document.

The term “generative AI model” refers to a machine-learning model that receives a prompt sentence and outputs generated content, such as natural language text, by probabilistic inference based on learned parameters.

The term “generation request” refers to a data packet or call, transmitted from the processor to the generative AI model, that includes at least the prompt sentence and optionally additional parameters controlling output characteristics.

The term “natural language text” refers to a sequence of characters or tokens in a human-readable language that can be interpreted as sentences, paragraphs, and sections by a human reader or by the system.

The term “draft of a contract document” refers to natural language text generated by the generative AI model that represents a preliminary version of a legal agreement subject to review and editing.

The term “contract clause unit” refers to a logical segment of the draft of a contract document, such as an article, section, or paragraph, having a distinct legal or functional meaning.

The term “document structure data” refers to metadata and structural information, including headings, numbering, and hierarchical relationships between contract clause units, that define the layout and organization of a contract document.

The term “document template” refers to a predefined format file or layout pattern containing placeholders and style settings, into which document structure data and text content are inserted to generate a formatted electronic document.

The term “contract document file” refers to an electronic document, such as a file in a portable document format or word processing format, that contains the content and structure of a contract in a form suitable for storage, display, transmission, and signing.

The term “electronic document format” refers to a file format for representing documents in digital form, including but not limited to formats for portable documents and word processing documents.

The term “editing operation” refers to an action performed by a user through the user interface to modify the content, structure, or formatting of the draft of a contract document or the contract document file.

The term “electronic signature request” refers to a command or message, issued by a user through the user interface to the processor, instructing that an electronic signature be applied to a contract document file.

The term “cryptographic algorithm” refers to a computational procedure, such as a hash function or encryption scheme, used by the processor to transform data in a manner that enables security functions including integrity protection and authentication.

The term “hash value” refers to a fixed-length data output computed from the content of a contract document file using a cryptographic hash function, such that a change in the file content results in a change in the hash value.

The term “secret key” refers to a cryptographic key that is kept confidential within the system or a secure component and is used by the processor to generate electronic signature data.

The term “electronic signature data” refers to digital information generated using a secret key and a hash value, which is embedded into a contract document file to bind the content of the file to a signer in a verifiable manner.

The term “storage” refers to a hardware and software subsystem, such as a database or file storage system, configured to persistently store contract management data and contract document files.

The term “contract management data” refers to data associated with contract documents, including contract-related information, version identifiers, status indicators, and indexing information used for management and retrieval operations.

The term “version information” refers to data that identifies and distinguishes different revisions of a draft of a contract document, including identifiers, time stamps, and status values.

The term “indexing” refers to a process of generating and maintaining search structures, such as inverted indexes or key-based maps, to enable efficient retrieval of contract management data based on search conditions.

The term “search condition” refers to one or more criteria provided by a user, such as keywords, contract type, date range, or party identifiers, that are used to select relevant items from indexed contract management data.

The term “past contract document” refers to a contract document file or its associated draft that has been previously generated, stored, and managed in the system and is available for retrieval and reuse.

The term “emotion analysis algorithm” refers to a computational procedure that processes user input information, such as text or interaction patterns, to estimate an emotional state of the user.

The term “emotional state” refers to an inferred condition of a user, such as satisfaction, hesitation, or urgency, derived from analysis of user input information by the emotion analysis algorithm.

The term “notification processing” refers to system operations for generating and delivering messages, alerts, or reminders related to a decision-making request, such as approval or confirmation of a contract, to one or more recipients.

The term “decision-making request” refers to information indicating that an action such as approval, authorization, or confirmation is required from a user or another party in relation to a contract or a contract-related process.

The term “control information” refers to data that specifies how the processor should adjust parameters of notification processing, including frequency, method, and expression content, in response to an estimated emotional state or other conditions.

The term “follow-up text” refers to textual content generated by the generative AI model for use in notifications or reminders that encourage a user or another party to respond to a decision-making request.

In one embodiment, a server cooperates with a terminal and a user to implement a contract document generation and management system using a generative AI model. The server includes at least one processor, a main memory, a non-volatile storage device, a network interface, and a cryptographic module. The terminal includes a processor, a display, an input device, and communication circuitry. The user interacts with the system through the terminal.

The server executes an operating system such as a general-purpose server operating system, and an application layer implemented for example in a high-level programming language framework, such as a web server framework or an application server framework. The server communicates with the terminal over a packet-based network using a secure transport protocol such as HTTPS. The server also communicates with an external generative AI model execution environment via an application programming interface exposed over the network.

The server maintains a database system such as a relational database or a document-oriented database. The server stores contract management data including structured representations of contract-related information, version identifiers, status values, and indexing data in the database. The server further maintains a file storage system, which may be implemented using a network file system or an object storage service, for storing contract document files in electronic document formats such as a portable document format or a word processing format.

The server executes a contract information structuring module that converts user-provided contract-related information into structured data. The server defines a schema including fields for a contract type, party identifiers, commercial parameters, jurisdiction information, effective dates, renewal conditions, and other contract attributes. The server normalizes user input into this schema by performing type conversion, trimming, normalization of date formats, and validation of numeric ranges. The server stores the structured data in the database in a table or collection where each record corresponds to a contract instance.

The server executes a prompt generation module that constructs a prompt sentence for a generative AI model. The server applies a deterministic formatting rule set that maps fields of the structured data schema to human-readable natural language phrases. For example, the server concatenates a header instruction with parameter descriptions. In one example, the server generates a prompt sentence in the following form:
“You are a legal contract drafting assistant. Create terms of service for an online streaming service.
Service name: StreamX
Monthly subscription fee: 1000 yen
Cancellation policy: Full refund if the user cancels within 30 days of initial registration.
Governing law: Japan
Output a complete contract document with section headings and numbered clauses.”

In another example, the server generates a prompt sentence in the following form:
“Draft a non-disclosure agreement between a disclosing party and a receiving party under Japanese law.

Include clauses on definition of confidential information, obligations of confidentiality, permitted disclosures, term, return or destruction of materials, and dispute resolution. Write in clear formal legal language with numbered articles.”

The server formats the prompt sentence as a message to be consumed by a generative AI model. The server may add system-level instructions, such as constraints on language, structure, and level of detail, and may include context from past contracts retrieved from the database. The server uses explicit rules to insert references to past clauses or prior drafts, for example by embedding excerpted text segments followed by modification instructions.

The server communicates with the generative AI model hosted on a computing platform that executes a transformer-based neural network. The generative AI model is trained in advance using a large corpus of natural language text and optionally specialized legal text. The generative AI model includes multiple layers of self-attention blocks, feed-forward networks, and embedding layers. During inference, the generative AI model receives tokenized representations of the prompt sentence and produces probability distributions over output tokens. The server configures generation parameters such as maximum token length, temperature, and nucleus sampling threshold to control the entropy and determinism of the output.

The server configures the generative AI model with fine-tuning parameters, in at least one embodiment, using supervised fine-tuning on contract data and reinforcement learning with preference feedback. The server, or an associated training system, defines an objective function that penalizes outputs with structural violations, such as missing mandatory sections or inconsistent numbering. The training process updates model weights by stochastic gradient descent or a variant thereof, minimizing the loss function derived from token prediction error and structural penalties. This improves the model's ability to output contract text that conforms to the system's structural constraints, thereby reducing post-processing overhead on the server.

The server executes a text analysis module that processes natural language text returned by the generative AI model. The server applies a sequence parser that detects clause boundaries, headings, and numbering patterns using regular expressions, finite-state machines, and optionally a separate shallow neural classifier. The server constructs document structure data as a hierarchical tree, where nodes represent sections, subsections, and clauses. Each node stores text content, heading text, numbering labels, and metadata such as clause type. The server stores this document structure data in the database or in memory as an intermediate representation.

The server executes a document templating module that maps the document structure data into a document template. The server maintains a template file with placeholders for a contract body, logos, margins, and signature blocks. The server programmatically inserts text segments into corresponding placeholders. For example, the server inserts a “Definitions” section into a predefined section labeled “Article 1” and assigns numbering based on the hierarchical position in the structure tree. The server uses a document generation library to render the combined template and content into a contract document file in an electronic document format.

The server executes a user interface back-end module that sends to the terminal either the rendered contract document file or the natural language text and structure data. The terminal renders the contract document on a display by invoking, for example, a viewer component available on the operating system, or by rendering HTML generated by the server. The user reads the contract document on the terminal and performs editing operations such as insertion, deletion, and modification of text. The terminal transmits edited content back to the server, which updates the document structure data and regenerates the contract document file as needed.

The server executes an electronic signature module that applies a cryptographic electronic signature to the contract document file. The server computes a hash value of the file content using a cryptographic hash function such as a member of the secure hash algorithm family. The server retrieves a secret key from a secure key store or a hardware security module and uses a digital signature algorithm such as a public key signature scheme to sign the hash value, generating signature data. The server embeds the signature data into the contract document file in a signature field that complies with a digital signature standard. The server thereby enables verification of integrity and authenticity of the signed file by any verifier that holds the corresponding public key.

The server executes a contract management module that maintains contract management data. The server assigns unique identifiers to each contract instance and each version. The server records metadata such as creation time, modification time, signer identity, and status flags. The server builds search indexes using structures such as inverted indexes and B-tree indexes. The server indexes not only free text from contract clauses but also structured fields from the contract-related information. This dual indexing allows the server to execute efficient queries combining keyword search with structured filters, which reduces the number of full-document scans and improves retrieval latency.

The server executes a reuse module that leverages past contract documents when generating new drafts. The server retrieves a selected past contract document and its structure data from storage based on search results. The server identifies sections that remain applicable and sections that require modification by comparing structured data fields and optionally running a difference computation between text segments. The server then constructs a new prompt sentence that includes excerpts or full clauses from the past contract, combined with instructions such as “adapt the following clauses to the new price and new party names.” This structure-aware reuse avoids re-generating content from scratch and reduces the computational load on the generative AI model, while also providing more consistent outputs.

The server further executes an emotion analysis module that estimates an emotional state of the user based on input information. The terminal collects user input text, interaction metadata such as editing frequency, delay between actions, and possibly acoustic or facial data if permitted. The server extracts features such as sentiment scores from text using a classifier model, timing statistics from interaction logs, and, optionally, recognized affective signals from sensor data. The server feeds these features into a machine learning model, such as a recurrent neural network or a transformer encoder fine-tuned for emotion classification, to obtain an emotional state label or probability distribution over emotional states.

The server uses the estimated emotional state to condition further processing. For example, the server modifies the prompt sentence to adjust writing tone, level of detail, and explicitness of explanations. The server may insert instructions such as “use explanatory language that reassures the reader” or “provide concise and direct clauses” depending on the emotional state. In addition, the server generates control information for notification processing. When a decision-making request is pending, the server adjusts the frequency and manner of notifications based on the emotional state, such as reducing frequency for a user inferred to be frustrated or increasing clarity of instructions for a user inferred to be confused.

The server may cause the generative AI model to generate follow-up text such as reminder emails or messages that are specifically tailored to the emotional state.

The server achieves a technical improvement in several respects. By converting user input into structured data at an early stage and by centralizing prompt sentence construction, the server reduces redundancy in parsing and validation across client devices. The structured prompt generation rules ensure that the generative AI model receives consistent, well-formed instructions, which reduces the variability of outputs and the need for extensive client-side corrections. This leads to reduced network traffic, because the terminal transmits mainly structured data and compact edits instead of full documents repeatedly.

The server's use of a hierarchical document structure representation, rather than only flat text, enables efficient editing operations and targeted regeneration. The server can re-generate only specific clauses or sections by constructing partial prompt sentences focused on those units. This selective regeneration reduces the number of tokens processed by the generative AI model and therefore reduces computational cost and latency. The server also minimizes format conversions by integrating document templating and signing in a single pipeline, avoiding multiple external conversions that would otherwise incur additional hashing and storage operations.

The server's contract management data indexing provides improved data management. The server uses composite indexes involving both structured fields and text fields, enabling precise filtering without scanning entire document contents. This reduces disk I/O and CPU cycles in search operations, which is particularly significant when managing a large corpus of contracts. The reuse module further increases computational efficiency by minimizing token-level generation for stable clauses and focusing the generative AI model on variable parts of the contract.

The server's emotion analysis module contributes to technical improvement by modulating internal parameters of prompt generation and notification generation based on quantified user state, rather than by simple rule-based triggers. By using machine-learned emotion classification, the server anticipates user behavior patterns and proactively adjusts communication. For example, when the emotion analysis module detects escalating frustration based on high editing frequency and negative sentiment in comments, the server reduces the number of follow-up reminders and instead prompts the generative AI model to generate clarifying explanations within the contract itself. This reduces unnecessary user interactions, lowers the number of network round-trips, and stabilizes system resource usage. The generative AI model employed by the server is not used as a generic black-box generator but is integrated into a specifically constrained contract drafting workflow. The server enforces non-conventional processing steps, including structured schema mapping, clause-level regeneration, and emotion-conditioned prompt construction. These steps are not conventional human drafting procedures; rather, they leverage the model's architecture and training regime to perform operations that humans do not typically execute, such as applying consistent normalization rules across thousands of contract instances in real time.

Alternative embodiments are also possible. In one alternative, the server executes an on-premises generative AI model instance instead of an external service. The server loads model parameters into a local GPU or specialized AI accelerator. The server manages inference using a model-serving framework, adjusting batch sizes and caching strategies to optimize throughput and latency. The same prompt construction, document structuring, and signing pipeline remain applicable in this configuration.

In another alternative embodiment, the terminal is a head-mounted display device, and the server streams formatted contract content as augmented-reality overlays. The terminal then captures gesture-based edits and voice commands and transmits them as structured edit operations to the server. The server continues to maintain the same contract management and signing pipeline, but the user interaction modality differs.

In yet another embodiment, the server integrates a rule-based pre-filter that checks for jurisdiction-specific mandatory clauses after the generative AI model outputs a draft. The server applies a rules engine that inspects the document structure data, verifying the existence and placement of specific clause types. If omissions are detected, the server constructs additional prompt sentences instructing the generative AI model to add missing clauses. This closed-loop combination of neural generation and deterministic rules improves reliability while maintaining efficiency.

In all embodiments, the server, the terminal, and the user cooperate such that the server performs core computational processes, including structured data generation, prompt sentence construction, generative AI model interfacing, contractual text structuring, document templating, cryptographic signing, indexing, search, reuse, and emotion-conditioned adaptation. By designing these modules as a unified pipeline, the system improves processing speed, output consistency, data management quality, and communication efficiency beyond what is achieved by conventional template-based or purely rule-based contract generation systems.

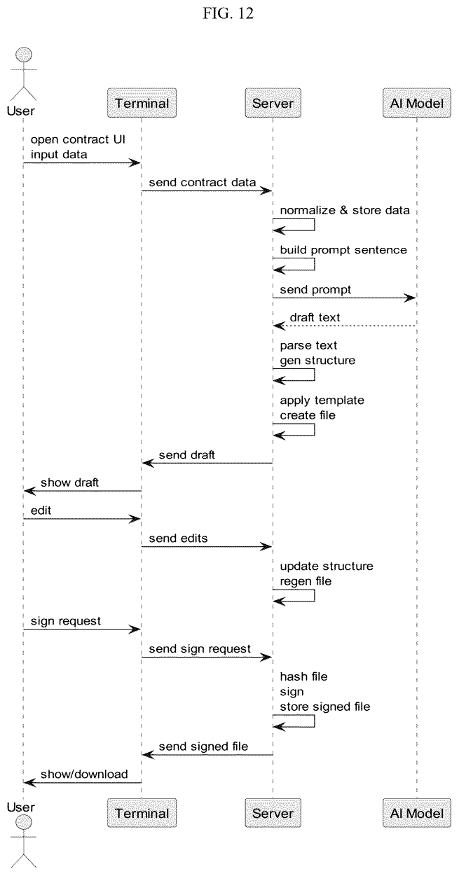

The following describes the processing flow using FIG. 12.

### Step 1:

User operates the terminal to open a contract creation screen.

User inputs contract-related information into form fields on the terminal, such as contract type, party identifiers, service name, monetary amounts, effective dates, and cancellation conditions.

Terminal receives this raw input as keystrokes and selections, aggregates the values into an internal data structure, and performs client-side validation (for example, checking that mandatory fields are not empty and that numeric fields contain digits only).

Input: Individual field values entered by the user (strings, selected options, dates, numbers).

Output: A validated parameter set on the terminal, represented as a structured object containing the contract-related information.

### Step 2:

Terminal transmits the structured parameter set to the server.

Terminal serializes the parameter set into a request message and sends it via a secure communication protocol to a designated application programming interface endpoint on the server.

Input: Structured parameter set in the terminal memory.

Output: Network request containing the contract-related information, delivered to the server.

### Step 3:

Server receives the request and parses the contract-related information.

Server invokes a request handler to deserialize the received message, map fields to an internal schema, and verify data types and value ranges.

Server performs normalization, such as trimming spaces, converting date formats into a standard representation, and converting numeric fields into a fixed-precision numeric type.

Input: Serialized request message with user-entered contract-related information.

Output: Normalized structured data stored in server memory, conforming to a predefined schema for contract instances.

### Step 4:

Server stores the normalized structured data in a database as a preliminary contract record.

Server generates a unique identifier, assigns an initial status to the record, and writes the structured fields to a persistent storage table or collection.

Server may also log metadata such as a timestamp and the identity of the user.

Input: Normalized structured data in server memory.

Output: Persistent contract record in the database with a unique contract identifier and associated metadata.

### Step 5:

Server constructs a prompt sentence for a generative AI model based on the structured data.

Server invokes a prompt construction module that reads specific fields (for example, contract type, service name, fee, governing law) and concatenates them with template text.

Server applies deterministic formatting rules to generate a coherent natural language instruction.

For example, the server constructs a prompt sentence such as:
“You are a legal contract drafting assistant. Create terms of service for an online streaming service.
Service name: StreamX
Monthly subscription fee: 1000 yen
Cancellation policy: Full refund if the user cancels within 30 days of initial registration.
Governing law: Japan
Output a complete contract document with section headings and numbered clauses.”

Input: Structured data retrieved from the database or memory.

Output: A complete prompt sentence in natural language format, ready to be sent to the generative AI model.

### Step 6:

Server optionally incorporates information from at least one past contract document into the prompt sentence.

Server accepts a reference to a past contract (for example, a prior contract identifier), retrieves the corresponding document structure data and text, and extracts relevant clauses.

Server inserts these clauses or summaries into the prompt sentence with explicit instructions such as “use the following language as a base and adapt it to the new parties and price.”

Input: Current structured data and retrieved past contract text and metadata.

Output: An augmented prompt sentence that combines new contract parameters and selected content from past contracts.

### Step 7:

Server applies an emotion analysis algorithm to user-related input information to adjust the prompt sentence.

Server receives user text comments, interaction metrics, or other signals, extracts features such as sentiment scores and interaction timing statistics, and infers an emotional state label.

Server modifies the prompt sentence by adding instructions consistent with the inferred emotional state, for example, “use reassuring and explanatory wording” or “use concise and direct language.”

Input: Original or augmented prompt sentence and emotion-related features derived from user data.

Output: An emotion-conditioned prompt sentence adapted to the inferred user emotional state.

### Step 8:

Server sends a generation request including the prompt sentence to the generative AI model.

Server encodes the prompt sentence into the required message format, attaches model configuration parameters (for example, maximum output length, temperature), and transmits the request over a network interface to a generative AI inference service.

Input: Final prompt sentence and generation parameters.

Output: A generation request delivered to the generative AI model, initiating text generation.

### Step 9:

Generative AI model processes the prompt sentence and returns a draft of a contract document as natural language text to the server.

Generative AI model tokenizes the prompt sentence, performs forward passes through a transformer architecture, and generates output tokens according to a probability distribution over the vocabulary.

The inference service assembles the tokens into text and returns the text as a response to the server.

Input: Prompt sentence and model configuration parameters.

Output: Natural language text representing a draft contract document, received by the server.

### Step 10:

Server analyzes the natural language text to identify clause boundaries and document structure.

Server applies parsing rules and pattern recognition, such as detecting numbered headings and key phrases, to divide the text into clause units and section units.

Server builds a hierarchical structure representation in which each node corresponds to a section, subsection, or clause, and stores labels, headings, and numbering for each.

Input: Natural language draft text from the generative AI model.

Output: Document structure data including segmented clauses, headings, and numbering, linked to the original text segments.

### Step 11:

Server maps the document structure data into a document template to generate a contract document file.

Server loads a predefined template containing layout definitions, fixed text, and placeholders for variable sections.

Server inserts clause texts from the document structure data into the corresponding placeholders, applies numbering and formatting rules, and composes a complete document.

Server uses a document generation library to render the composed content into an electronic document format.

Input: Document structure data and a template file.

Output: A formatted contract document file in an electronic document format stored in server memory or temporary storage.

### Step 12:

Server persists the contract document file in file storage and updates the database with a reference.

Server assigns a file path or object identifier, writes the file to storage, and records the association between the contract identifier and the file reference in the contract management data.

Server updates version information to indicate that a new draft document file has been created.

Input: Contract document file generated in memory and existing contract record.

Output: A stored contract document file and updated contract management data with a link to the stored file.

### Step 13:

Server sends to the terminal data for displaying the draft contract to the user.

Server prepares a response that includes either a link to the document file or the text content and structure metadata.

Terminal receives the response, fetches the file if necessary, and renders the document on the display using a viewer or text rendering engine.

Input: Stored document file reference or document content and structure data.

Output: Visual representation of the draft contract on the terminal for user review.

### Step 14:

User reviews the displayed contract and performs editing operations on the terminal.

User selects text portions, inserts new text, deletes or replaces clauses, and may add comments.

Terminal applies these edits to an internal representation of the document, updating text segments and maintaining an association with clause identifiers or locations.

Input: Displayed contract and user editing actions (selections, keystrokes, commands).

Output: An edited version of the contract text and associated structural adjustments in the terminal memory.

### Step 15:

Terminal transmits the edited content and corresponding identifiers back to the server.

Terminal compiles the edited text and, where available, structural markers into an update request specifying the contract identifier and the sections that were changed.

Terminal sends this request via the communication channel to the server.

Input: Edited contract text and contract identifier on the terminal.

Output: Update request containing edited content delivered to the server.

### Step 16:

Server integrates the edited content into the document structure data and regenerates the contract document file if needed.

Server locates the corresponding clause nodes in the existing document structure data and replaces or updates their text fields with the edited content.

Server then re-renders the updated document through the templating module to produce a new version of the contract document file.

Input: Update request with edited content and existing document structure data.

Output: Updated document structure data and a new version of the contract document file stored in memory.

### Step 17:

Server updates contract management data with a new version record.

Server increments a version number or creates a new version entry, associates it with the contract identifier, and stores metadata such as modification time and editor identity.

Server optionally preserves differences between versions to support later comparison.

Input: Updated contract document file and existing contract record.

Output: Persisted versioned contract management data and storage of the updated document file.

### Step 18:

User initiates an electronic signature operation on the terminal.

User confirms that the displayed version is final and selects a signing function in the terminal interface.

Terminal may authenticate the user locally or via an external identity provider and prepares a signing request containing the contract identifier and user credentials or tokens.

Input: User confirmation and authentication data on the terminal.

Output: Electronic signature request message transmitted from the terminal to the server.

### Step 19:

Server processes the electronic signature request and prepares the contract document for signing.

Server validates user authorization using received tokens or credentials and retrieves the latest contract document file associated with the contract identifier from storage.

Server loads the file into memory and verifies its consistency with the version expected by the user.

Input: Electronic signature request and stored contract document file.

Output: Verified contract document file in server memory ready for cryptographic processing.

### Step 20:

Server applies a cryptographic hash function to the contract document file and generates electronic signature data.

Server computes a hash value over the file byte sequence using a specified hash algorithm, then retrieves a secret key from a secure key store.

Server executes a digital signature algorithm with the secret key and hash value to produce signature data.

Server embeds the signature data and associated metadata, such as signing time and signer identity, into the contract document file in a designated signature field.

Input: Contract document file in memory and secret key material.

Output: Signed contract document file containing embedded electronic signature data.

### Step 21:

Server stores the signed contract document and updates contract management data to reflect a signed status.

Server writes the signed file to storage, updates the contract record with a reference to the signed file, and modifies status fields to indicate that the contract is signed.

Server may also log signing events for audit purposes.

Input: Signed contract document file and existing contract management record.

Output: Persisted signed contract document and updated contract management data with a signed status.

### Step 22:

Server sends the signed contract document to the terminal for final display and distribution.

Server provides a link or binary content of the signed file to the terminal.

Terminal receives and opens the signed file, displays visual indicators of the electronic signature, and allows the user to download, archive, or share the document through communication functions available on the terminal.

Input: Signed contract document and terminal request for retrieval.

Output: Displayed signed contract on the terminal and optional local or remote copies controlled by the user.

### Step 23:

Server continuously maintains search indexes over contract management data and contract text.

Server extracts key fields and text content from each versioned contract, updates index structures used by a search engine, and maintains mappings from search terms to document identifiers.

Server periodically or incrementally updates these indexes when new contracts are created, edited, or signed.

Input: Newly stored or updated contract management data and document text.

Output: Updated searchable index structures enabling efficient retrieval of past contracts.

### Step 24:

User performs search and reuse operations through the terminal.

User specifies search criteria, such as contract type, party name, date range, or keywords, via the terminal interface.

Terminal transmits the search criteria to the server, which executes index-based queries, retrieves matching contract identifiers, and returns summaries to the terminal.

User selects a past contract as a base for a new contract, and the terminal sends a reuse request referencing the selected contract.

Input: Search criteria and reuse request from the terminal.

Output: List of matching past contracts presented to the user and a reuse reference transmitted to the server.

### Step 25:

Server retrieves selected past contract data and constructs a new prompt sentence for generating a new draft.

Server loads the full text and structure of the selected past contract, compares its structured parameters to the new contract-related information, and identifies clauses to reuse and clauses to adapt.

Server builds a new prompt sentence including relevant past clauses and explicit instructions for adjustments, then optionally applies emotion-based modifications as previously described.

Input: Reuse reference, past contract text and structure data, and new structured data for the current contract.

Output: A reuse-based prompt sentence formatted for submission to the generative AI model to generate a new draft contract.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented contract management systems generally treat contract generation, contract analysis, and approval workflow control as separate and weakly coupled functions. In typical implementations, a contract template engine generates a draft contract on the basis of static templates, a separate module or human operator extracts key parameters such as contract amount and term, and a workflow engine is manually configured to route the contract for approval. Such fragmentation requires repeated data entry and manual rule interpretation, causes inconsistencies between the generated contract text and the approval route, and leads to latency and errors in enterprise decision-making. From a computer technology perspective, existing systems also fail to efficiently exploit advances in generative AI models and real-time sentiment analysis in an integrated architecture. A generative AI model may be called merely as a black-box text generator, without structured feedback of its outputs into machine-readable approval parameters and workflow states. As a result, servers frequently perform redundant parsing and rule evaluation, maintain multiple copies of partially overlapping state, and rely on ad hoc scripts to synchronize document content, approval rules, and notification logic. This increases processing complexity, burdens memory and storage subsystems, and complicates the design and maintenance of scalable, robust server-side software.

Moreover, conventional notification subsystems are typically static: follow-up messages regarding approval status are sent at fixed intervals and through predetermined channels regardless of the user's current sentiment or engagement level. This rigidity leads to excessive or insufficient notifications, unnecessary network traffic, and suboptimal utilization of processing resources on both server and client devices. In addition, user feedback such as comments and clarifications is often handled out-of-band, and is not systematically reintegrated into the contract text through automated regeneration. This forces users to manually reconcile changes, undermining the efficiency gains expected from computerization.

Accordingly, there is a need for an improved computer-implemented system and server-side processing architecture that (i) tightly integrates generation of contract documents by a generative AI model with structured extraction of approval parameters and automatic construction of approval workflows, (ii) unifies management of workflow state, notification control, and contract revisions within a single, consistent data model, and (iii) dynamically adapts generation instructions and notification behavior based on automatically derived sentiment information, thereby improving the technical efficiency, reliability, and responsiveness of contract processing in a networked computing environment.

The specific processing by the specific processing unit 290 of the data processing device 12 in Example 2 is realized by the following means.

The present invention provides a server comprising a processor configured to execute program instructions to analyze contract-related information including input information acquired from a user terminal and to generate a prompt sentence for instructing a generative AI model to generate a contract document on the basis of a result of the analysis and predetermined document generation conditions, to receive contract document data generated by the generative AI model in response to the prompt sentence, to output the contract document data as document-format data, and to cause a user interface to display the document-format data so as to accept viewing and editing operations by a user; the processor further configured to analyze text data including the contract document data and to extract structured information including amount information, period information, counterpart information, region information, and contract type information, to automatically generate workflow information representing an approval request flow by specifying required approval entities, an approval order, and an approval scheme on the basis of the structured information and predetermined approval condition information and approval route information, and to generate approval request tasks on the basis of the workflow information, to transmit notification information corresponding to the approval request tasks via a communication unit, and to manage approval state information so as to automatically control progress of the approval request flow; the processor further configured to acquire the approval state information and the workflow information and to generate display data enabling real-time presentation of progress status of the approval request flow to the user terminal as status information, to generate an additional input prompt sentence for revising the contract document data on the basis of comment information or additional information acquired from the user, to cause the generative AI model to generate revised contract document data on the basis of the additional input prompt sentence, and to update the workflow information and the approval state information in accordance with the revised contract document data; and the processor further configured to analyze user input information by using a sentiment analysis algorithm to generate sentiment information, to modify contents of instructions to the generative AI model so as to adjust textual characteristics of the contract document data on the basis of the sentiment information, and to generate control information for dynamically adjusting at least one of a notification mode and a notification frequency of the approval state information. This enables an integrated computer-implemented contract processing architecture in which generation of contract documents, extraction of approval parameters, automatic construction and progression of approval workflows, dynamic notification control, and iterative contract regeneration are coordinated within a unified server-side processing framework, thereby reducing redundant processing, improving consistency between document content and workflow state, optimizing use of communication and computation resources, and enhancing the responsiveness and reliability of contract management operations in a networked computing system.

The term “processor” refers to a hardware information processing unit, such as a central processing unit or a programmable logic device, configured to execute instructions stored in a memory to perform the functions described in the present specification.

The term “user terminal” refers to an information processing device operated by a user, such as a personal computer, a tablet device, or a smartphone, which is capable of transmitting input information to a server and displaying information received from the server.

The term “contract-related information” refers to information associated with creation, modification, or approval of a contract, including input information provided by a user, metadata such as contract type or counterpart, and any other data used for generating or processing a contract document.

The term “prompt sentence” refers to a text or structured instruction provided to a generative AI model, which specifies conditions, constraints, or purposes for generating or revising a contract document.

The term “generative AI model” refers to an information processing model that generates text output, including contract document data, in response to a prompt sentence by performing machine learning-based inference such as natural language generation.

The term “contract document” refers to a textual representation of rights and obligations agreed or to be agreed between parties, including a draft, a revised version, or a final version of a legal or quasi-legal document.

The term “contract document data” refers to digital data representing the content of a contract document in a machine-readable format, including plain text, structured text, or encoded document data.

The term “document-format data” refers to contract document data converted or formatted for presentation or storage, including formats suitable for display, printing, or archival, such as markup-based or page layout-based formats.

The term “user interface” refers to a software or hardware interface that presents information to a user and accepts operations from the user, including graphical user interfaces, web interfaces, and application-specific display and input components.

The term “text data” refers to data consisting of characters, words, or sentences, including the content of contract document data and any associated textual annotations or comments.

The term “structured information” refers to information represented in a predetermined data structure or schema, such as key-value pairs, records, or objects, enabling programmatic access, comparison, and rule evaluation.

The term “amount information” refers to structured information indicating a monetary value associated with a contract, including numerical amounts and related currency identifiers.

The term “period information” refers to structured information indicating a temporal range or duration related to a contract, such as a start date, end date, or term length.

The term “counterpart information” refers to structured information identifying one or more entities that are parties to a contract, such as organizations or individuals, including their roles in the contract.

The term “region information” refers to structured information indicating a geographical area, jurisdiction, or territory to which a contract applies or in which the contract is to be performed.

The term “contract type information” refers to structured information indicating a classification or category of a contract, such as a nondisclosure agreement, a master agreement, a sales agreement, or a license agreement.

The term “workflow information” refers to structured information representing a sequence or network of processing steps, tasks, and states constituting an approval request flow for a contract document.

The term “approval request flow” refers to a sequence of operations or states through which a contract document is submitted to one or more approval entities, evaluated, and either approved, rejected, or returned for revision.

The term “approval entities” refers to organizational units, roles, or individual users that are authorized to review and approve or reject a contract document within the approval request flow.

The term “approval order” refers to a sequence or arrangement specifying the order in which approval entities are to perform approval operations in the approval request flow.

The term “approval scheme” refers to a mode or pattern of approval, including whether approvals are to be performed sequentially, in parallel, by all entities, or by one of a group of entities.

The term “approval condition information” refers to structured information defining conditions, thresholds, or criteria for determining which approval entities are required, in which order, and under what circumstances.

The term “approval route information” refers to structured information specifying mapping rules between contract-related parameters and one or more sequences of approval entities forming an approval path.

The term “approval request task” refers to a unit of work generated for an approval entity, requiring an approval operation such as approval, rejection, or commenting with respect to a contract document.

The term “notification information” refers to information used to inform a user or approval entity about a state, event, or required action in the approval request flow, including message content, destination, and delivery parameters.

The term “communication unit” refers to hardware and software components of the server that transmit and receive data over a communication network, including network interfaces, communication protocols, and messaging modules.

The term “approval state information” refers to structured information indicating a current state of one or more approval request tasks or the overall approval request flow, including statuses such as pending, approved, rejected, or revised.

The term “status information” refers to information derived from approval state information and workflow information for presentation to a user, indicating progress, current approvers, and related timestamps.

The term “display data” refers to data generated for rendering on a user interface, including layout, text, symbols, and other elements representing status information or contract content.

The term “comment information” refers to text or annotation data input by a user regarding a contract document, such as requests for changes, clarifications, or internal notes.

The term “additional information” refers to information other than comment information that is provided by a user and used for revising or supplementing a contract document, such as attachments, parameters, or external references.

The term “revised contract document data” refers to contract document data that has been newly generated or updated by the generative AI model on the basis of an additional input prompt sentence, comment information, or additional information.

The term “sentiment analysis algorithm” refers to a computational procedure that analyzes user input information to derive sentiment information, such as emotional tone or attitude, using techniques including rule-based processing, statistical modeling, or machine learning.

The term “sentiment information” refers to structured information representing an estimated emotional state or attitude of a user, derived from user input information by the sentiment analysis algorithm.

The term “textual characteristics” refers to properties of a generated contract document's text, including tone, politeness level, degree of formality, or emphasis on particular clauses.

The term “control information” refers to structured information used by the server to adjust processing behavior, including parameters for notification modes, notification frequencies, or generation instructions supplied to the generative AI model.

The term “notification mode” refers to a manner in which notification information is delivered, including a communication channel, message format, or user interface modality.

The term “notification frequency” refers to a rate or pattern at which notification information is sent, including timing intervals, conditions for repeated messages, and escalation schedules.

In one embodiment, a server cooperates with one or more terminals to implement the above-described system. The server includes at least one processor, a main memory, a nonvolatile storage device, and a network interface. The processor can be a general-purpose central processing unit or a graphics processing unit. For example, the server can include an x86-compatible CPU and a GPU such as a general-purpose graphics processor connected via a high-speed interconnect. The main memory can be a volatile semiconductor memory such as dynamic random access memory. The nonvolatile storage device can be a solid-state drive or a magnetic disk device. The network interface can be configured to communicate over an internet protocol network using secure transport such as HTTPS.

The terminal is operated by a user and can be realized by a personal computer, a tablet device, or a smartphone. The terminal executes a web browser or a dedicated application, and displays a user interface for inputting contract-related information and a prompt sentence. The user operates the terminal to input parameters such as contract type, parties, amount, term, governing region, and free-text instructions. The terminal converts the input to a data structure and transmits the data to the server via the network interface. The terminal also receives status information and contract document data from the server and renders them on a display.

The server stores, in the nonvolatile storage device, a plurality of software modules. In one example, the server executes an operating system, a web server such as a generic HTTP server, an application framework implemented, for example, in a high-level language runtime, a database management system such as a relational database engine, and a workflow engine. The server also stores model parameters of a generative AI model and parameters of a sentiment analysis algorithm. The processor loads these software modules and parameters into the main memory and executes them.

The server uses the application framework to receive, via the web server and the network interface, contract-related information and a prompt sentence from the terminal. The server then performs preprocessing of the received data. The server normalizes characters, tokenizes text, and maps user selections such as contract type into canonical identifiers stored in a contract type master table in the database management system. The server constructs an internal data structure, for example, a record stored in a contracts table, including fields such as contract_id, user_id, contract_category_code, amount_value, currency_code, region_code, and raw_prompt_text.

The server then generates a first prompt sentence to be supplied to the generative AI model. The server concatenates a system-level instruction template and the user's raw prompt text. The system-level instruction template is stored in a template table and includes constraints on structure, language style, and clause ordering. For example, the server can generate a first prompt sentence such as:
“Generate a complete sales contract between a supplier and a corporate customer. Use clear, formal language. Include sections for definitions, scope of supply, price and payment terms, delivery, warranties, limitation of liability, term and termination, and governing law. Follow these parameters: contract type=sales, governing region=Japan, contract amount=20,000,000 JPY, term=1 year. Draft the contract in Japanese.” As another example, the server can generate a first prompt sentence such as:
“Draft a license agreement for a software subscription service, with data protection clauses compliant with applicable data protection regulations. The agreement should be bilingual (Japanese and English). Include clauses on subscription scope, service levels, data processing, security, limitation of liability, and termination. Contract amount=50,000,000 JPY per year, term=1 year, automatic renewal.”

The server supplies the first prompt sentence to the generative AI model. In one embodiment, the generative AI model is a neural network-based language model stored in the server or in a connected computing resource. The generative AI model can have a transformer architecture including an input embedding layer, a plurality of self-attention layers, feedforward layers, and an output projection layer. The model parameters are learned in advance by supervised learning and unsupervised learning on a large corpus of text including legal documents. The model processes discrete token sequences representing the prompt sentence and iteratively computes, for each token position, attention weights, intermediate activations, and probability distributions over a vocabulary. The model then outputs a sequence of tokens representing contract document data.

In one variant, the server accesses a remote generative AI model via an application programming interface over HTTPS. The server transmits the first prompt sentence and model parameters, such as temperature, maximum token length, and top-k or top-p sampling parameters, to the remote model, which returns generated text. In another variant, the server executes a local generative AI model on the GPU using a framework such as a tensor computation library, performing matrix multiplications and nonlinear transformations to compute the output tokens. In both cases, the server receives contract document data as a text sequence.

The server post-processes the contract document data. The server removes extraneous tokens, normalizes spacing, enforces a predefined section ordering, and identifies clause headings using pattern matching. The server stores the post-processed contract document data in the contracts table and associates it with the corresponding contract_id. The server then prepares the contract document data for display by converting it into a document-format data structure, such as markup including headings, paragraphs, and numbered lists. The server transmits the document-format data to the terminal, where the terminal renders the contract on the display. The user can read, scroll, and edit specific sections using the user interface.

The server further analyzes the contract document data to extract structured information. The server applies a sequence of operations that combine rule-based analysis and learned models. The server first performs tokenization and sentence segmentation using a natural language processing library. The server then applies pattern-based extractors using regular expressions to capture monetary amounts, date expressions, and explicit period descriptions such as “for a period of 12 months.” The server converts textual numbers and formats such as “20,000,000 yen” into a normalized numeric field amount_value and records a currency_code.

The server also uses a text classification model to infer contract type and region when they are not explicitly encoded in the metadata. The text classification model can be realized as a smaller neural network that consumes sentence-level embeddings from a pre-trained language encoder. The server feeds section headings and representative clauses into this classifier to obtain probability scores over contract type classes and region codes. The server then selects the highest-probability class exceeding a threshold.

In addition, the server can use a second generative AI model, which may share the same architecture as the first but is fine-tuned for extraction tasks. The server supplies a second prompt sentence, such as:
“Extract, in a structured form, the key approval parameters from the following contract: contract amount, currency, contract type, initial term length, renewal conditions, governing region, presence of data processing obligations, and whether personal data of residents of certain regions is processed. Return the result as labeled fields.”

The server appends the full contract document data after the second prompt sentence and obtains a structured text output representing key-value pairs. The server parses this output and merges it with the results from the rule-based extractors. By combining rule-based and model-based extraction, the server reduces errors associated with purely template-based approaches and handles variations in language used in the contract document data.

The server stores the extracted structured information in a contract_parameters table. Each record includes fields such as contract_id, amount_value, currency_code, initial_term_months, renewal_flag, region_code, contract_category_code, and data_processing_flag. The server also validates the structured information by checking consistency constraints, such as verifying that end date is later than start date and that amount_value is positive. By storing structured information in normalized database tables, the server enables efficient indexed queries for rule evaluation and reporting, thereby improving data management.

The server then generates workflow information for an approval request flow. The server stores, in the database, approval condition information and approval route information. The approval condition information is expressed as machine-interpretable rules. For example, rules can be expressed as records defining thresholds and conditions: if amount_value≥threshold_1 and region_code equals a particular code, include a certain role as an approval entity; if data_processing_flag is true and region_code is within a specified set, include a data protection role.

The server evaluates these rules programmatically by executing conditional branches and comparisons within the processor, rather than through manual configuration. In one configuration, the server uses a rules engine that loads decision tables or decision graphs; in another configuration, the application code embodies the rules directly. The server determines a list of approval entities and an approval order. The server then constructs workflow information as a sequence or graph of nodes, each node representing an approval request task with attributes such as approver_id, required_action, and state. By computing the workflow information automatically from structured information, the server avoids human errors inherent in manual routing and guarantees consistency between the contract document data and the approval path. In addition, because the workflow information is stored in the database in a normalized form tied to the contract_id, the server can efficiently update and query the state of each approval request task.

The server generates approval request tasks from the workflow information and persists them in a workflow_tasks table. The server assigns each task a unique identifier, initial state, and due date. The server then creates notification information for each active task and passes the notification information to the communication unit. The communication unit formats messages for delivery via one or more channels, such as electronic mail, in-application notifications, or mobile push notifications. The server records the success or failure of each notification transmission and associates this information with the corresponding approval request task.

The terminal periodically acquires, from the server, approval state information and workflow information associated with a contract_id. The server aggregates state information across all approval request tasks to derive an overall status such as “pending initial approval,” “approved by sales,” or “fully approved.” The server generates display data that encodes progress indicators, lists of approvers, and timestamps. The terminal then renders a status screen that allows the user to visually track the approval request flow.

The user can provide comment information or additional information via the terminal. For example, the user can enter text such as “Please clarify the payment due date; change it to net 30 days” or can upload a document describing internal pricing conditions. The terminal transmits the comment information and additional information to the server. The server stores the information in comment tables and file storage, and associates them with the contract_id.

The server uses the received comment information to generate an additional input prompt sentence for revising the contract document data. For instance, the server can construct an additional input prompt sentence such as:
“Revise the following contract so that the payment term is clearly stated as net 30 days from the invoice date. Do not change any other clauses. Here is the current contract text: [contract body]”

The server supplies this additional input prompt sentence and the existing contract document data to the generative AI model. The model regenerates the relevant parts of the contract, maintaining consistency in numbering and references. The server then integrates the revised segments into the contract document data and stores revised contract document data linked to a new version number. The server also determines, from a revision rule set, whether certain approval request tasks must be reset due to the revision. The server updates the workflow information and approval state information accordingly.

The server performs sentiment analysis on user input information. The server applies a sentiment analysis algorithm implemented as a neural network, such as a bidirectional recurrent network or a transformer-based classifier, that has been trained on labeled data indicative of emotional tone. The server converts user comments into token sequences, feeds them into an embedding layer, and propagates them through several attention or recurrent layers. The final hidden state is mapped to sentiment scores, such as positive, neutral, and negative, or to a continuous valence-arousal space. The server stores the sentiment information with a reference to the user and the contract.

The server uses the sentiment information in two distinct ways. First, the server adjusts textual characteristics of subsequent prompts to the generative AI model. For a user who exhibits a tendency toward dissatisfaction or confusion, the server modifies the system-level part of the prompt sentence to instruct the model to generate more explanatory or cautious language. For example, the server can adjust a part of the system instruction to “use especially clear, explanatory wording and avoid ambiguous phrases.” By encoding sentiment-conditioned style parameters into the prompt sentence, the server causes the model to generate output better aligned with the user's state, which reduces subsequent clarification cycles and thus reduces both processing load and communication overhead.

Second, the server adjusts notification mode and notification frequency. If sentiment information indicates frustration in relation to delayed approvals, the server increases the priority of notifications to certain approvers or escalates notifications through additional channels. Conversely, if sentiment information indicates overload or annoyance due to frequent notifications, the server decreases notification frequency or switches to less intrusive channels. The server represents these adjustments as control information containing updated thresholds, intervals, and channel preferences. The communication unit inspects the control information and alters its scheduling and routing of messages. Because these adjustments are computed algorithmically and stored as explicit parameters, the system adapts notification behavior without requiring manual reconfiguration.

The described architecture yields technical effects that go beyond automation of human tasks. By tightly integrating generative AI model processing with structured information extraction and workflow computation within a single server-side data flow, the server reduces redundant parsing and avoids inconsistencies caused by separate systems. Centralizing structured information in a normalized database enables indexed retrieval and rule evaluation that scale with the number of contracts and users. In addition, by using a transformer-based generative AI model that has been trained to output contracts in a constrained style, and by combining this with rule-based extraction and a second model fine-tuned for extraction, the server reduces extraction errors compared to simple keyword-based or manual approaches, improving the precision of approval route determination.

From a computational standpoint, the server improves processing efficiency by batching requests to the generative AI model and by reusing intermediate representations. For example, tokenized versions of contract document data can be cached and reused both for extraction and for subsequent revisions, avoiding repeated tokenization and reducing compute cycles on the processor and GPU. The server can also compress and cache structured information to accelerate rule evaluation for similar contracts.

In another embodiment, the server utilizes model distillation for the sentiment analysis algorithm, where a smaller network is trained to approximate the output of a larger reference model. This reduces inference time and memory requirements on the server, which is especially beneficial when processing a high volume of user comments in real time. The server employs techniques such as mini-batch processing and vectorized operations on the processor and GPU to further improve throughput.

The combination of these techniques enhances the technical performance of the computing system. The server reduces latency between contract generation and workflow construction, decreases the number of database write and read operations required to maintain consistency, and lowers bandwidth usage by generating fewer, more relevant notifications. These improvements in speed, resource utilization, and accuracy constitute improvements in computer technology rather than mere automation of business processes.

In still another embodiment, the server can be configured with alternative generative AI models or architectures. For example, the server can employ a recurrent network-based language model, a convolutional sequence model, or a hybrid architecture with external memory. The server can also vary training methods, such as supervised fine-tuning on domain-specific contracts, reinforcement learning using human preference signals for contract clarity, or curriculum learning where models are exposed to progressively more complex contract structures. The training process can use an objective function that combines cross-entropy loss with penalties for generating structurally invalid clauses. Weights are updated using stochastic gradient descent or variants thereof, such as adaptive moment estimation. These implementation details yield models that more reliably generate machine-parseable contracts, further simplifying downstream extraction and rule evaluation.

In a further embodiment, the server can implement an adaptive rules mechanism. The server monitors discrepancies between predicted approval routes and actual routes taken after manual overrides. The server then updates rule thresholds or adds new rule entries based on aggregated feedback, using optimization algorithms that balance coverage and complexity. This adaptation can be performed offline and then deployed as updated approval condition information. As a result, rule evaluation becomes more aligned with operational requirements without manual rewriting of complex rule sets.

In another variant, the terminal can be a specialized device installed in an enterprise environment. The terminal may integrate with local authentication mechanisms such as smartcard readers or biometric sensors. The terminal can offload certain rendering and caching tasks from the server, such as local storage of frequently viewed contract templates, which reduces repeated data transmission and network load. The server and the terminal cooperate to maintain synchronized views of contract document data and approval state information using mechanisms such as version numbers and timestamps.

The described embodiments illustrate examples of how the server, terminal, and user cooperate to implement the invention. Variations in hardware platform, software stack, data structures, and model architectures can be made without departing from the scope of the claims, as long as the server is configured to generate prompt sentences for a generative AI model, to generate and analyze contract document data, to compute workflow information, to control approval request flows and notifications, and to adapt text generation and notification behavior based on structured information and sentiment information in the manner described.

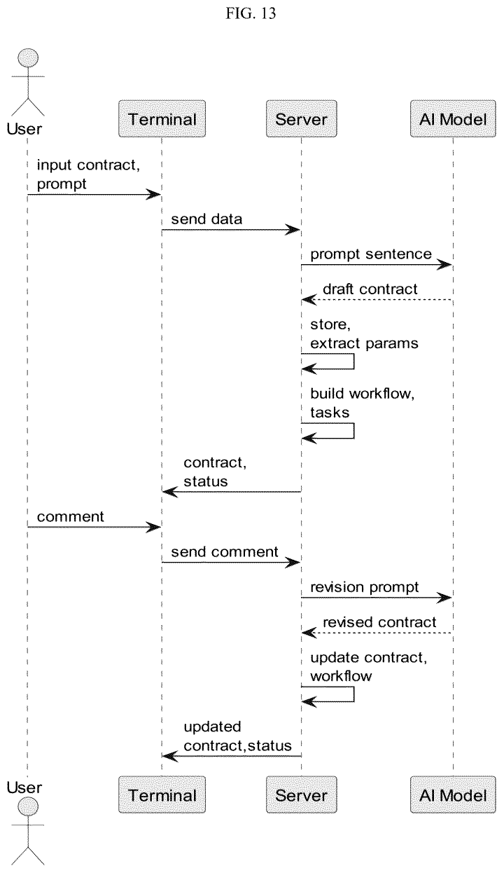

The following describes the processing flow using FIG. 13.

### Step 1:

The user operates the terminal to open a contract generation screen and inputs contract-related information and a free-text prompt sentence.

The input includes items such as contract type, counterpart name, contract amount, term, and a prompt sentence like “Generate a sales contract for a new B2B customer with an annual contract value of 20 million JPY and a one-year term.”

The terminal validates that required fields are filled, performs basic checks such as numeric validation for the amount, and converts the input into an internal data structure.

The output of this step is structured input data on the terminal containing the user's contract-related parameters and the prompt sentence.

### Step 2:

The terminal transmits the structured input data to the server via a network connection using a secure protocol.

The input to this step is the structured input data held by the terminal after local validation.

The terminal encodes the data into a request, attaches metadata such as user identifier and device information, and sends the request to a predefined API endpoint on the server.

The output of this step is a network message received by the server containing the contract-related parameters and the prompt sentence.

### Step 3:

The server receives the network message and parses the contract-related parameters and the prompt sentence.

The input to this step is the network message from the terminal.

The server decodes the message, normalizes text (for example, trims whitespace and standardizes character encodings), and stores the raw values into temporary variables in memory.

The output of this step is normalized input data in server memory, including cleaned contract parameters and a cleaned prompt sentence.

### Step 4:

The server generates a first prompt sentence for a generative AI model based on the normalized input data and stored document generation conditions.

The input to this step is the normalized contract parameters, the cleaned prompt sentence, and template data stored in a database or configuration file.

The server concatenates a system-level instruction template (for example, “You are a legal document generator. Use formal style and include mandatory clauses.”) with the user's cleaned prompt sentence and inserts structured parameters such as contract type, amount, and region into placeholders.

The output of this step is a formatted first prompt sentence that is suitable for direct submission to the generative AI model.

### Step 5:

The server submits the first prompt sentence to the generative AI model and obtains generated contract document data.

The input to this step is the formatted first prompt sentence and generative AI model configuration parameters such as temperature and maximum token count.

The server calls the generative AI model via an internal interface or an external API, provides the prompt sentence as tokenized input, and receives a sequence of output tokens that the server decodes into text representing a contract document.

The output of this step is raw contract document data in text form stored in server memory.

### Step 6:

The server post-processes the raw contract document data and stores it in persistent storage.

The input to this step is the raw contract document text generated by the generative AI model.

The server normalizes line breaks and spacing, detects section headings using pattern matching, and enforces a predefined order of clauses; then the server creates a new record in a contracts table and writes the processed contract text along with identifiers and timestamps.

The output of this step is a stored contract record containing post-processed contract document data associated with a unique contract identifier.

### Step 7:

The server converts the stored contract document data into document-format data suitable for display and sends it to the terminal.

The input to this step is the processed contract document text retrieved from the contracts table using the contract identifier.

The server wraps headings, paragraphs, and lists in display markup or structured elements and builds a response message containing this document-format data, which is then transmitted to the terminal.

The output of this step is a network response containing document-format data that the terminal can immediately render.

### Step 8:

The terminal receives the document-format data and displays the contract to the user for confirmation and editing.

The input to this step is the server's response containing the document-format data.

The terminal parses the markup, constructs visual components such as sections and editable fields, and renders the contract on the display while enabling editing actions like text selection and modification by the user.

The output of this step is a rendered contract view on the terminal and, optionally, locally buffered edited content if the user makes changes.

### Step 9:

The server analyzes the contract document data to extract structured information such as amount, period, counterpart, region, and contract type.

The input to this step is the finalized or current version of contract document text retrieved from storage.

The server tokenizes sentences, applies regular expressions to detect monetary expressions and date ranges, and uses classification models to infer contract type and region; from these operations, the server constructs a structured record with normalized numeric values and coded identifiers.

The output of this step is structured information stored in a contract_parameters table, including fields like amount_value, currency_code, term_length, region_code, and contract_category_code.

### Step 10:

The server evaluates approval rules and generates workflow information for an approval request flow.

The input to this step is the structured information from the contract_parameters table and predefined approval condition information and approval route information stored in rule tables.

The server compares values such as amount_value and region_code to rule thresholds, selects appropriate approval entities, determines the approval order and scheme, and constructs workflow information as a sequence or graph of approval steps linked to roles or user identifiers.

The output of this step is workflow information stored in workflow-related tables, including the list of approval entities and the defined approval route for the contract.

### Step 11:

The server generates approval request tasks based on the workflow information and prepares notification information for each task.

The input to this step is the workflow information that includes identified approval entities and step order.

The server creates individual approval task records with task identifiers, assignee identifiers, due dates, and initial states, and builds notification messages summarizing the contract and required action for each active approver.

The output of this step is a set of approval request task records stored in a workflow tasks table and a set of notification information objects ready for transmission.

### Step 12:

The server transmits notification information via the communication unit and initializes approval state information.

The input to this step is the notification information for each approval request task and the initial approval state of each task.

The server sends messages through configured channels such as email or push notifications, records transmission results, and initializes approval state records indicating that tasks are pending and awaiting action.

The output of this step is delivered notifications to approvers and stored approval state information reflecting the current status of each task and the overall approval request flow.

### Step 13:

The terminal acquires approval state information and workflow information from the server and displays the progress of the approval request flow.

The input to this step is the server's response containing up-to-date approval state information and workflow information linked to a contract identifier.

The terminal parses status fields, maps them to graphical indicators such as progress bars and status labels, and renders a status screen showing which approval steps are completed, which are pending, and which are rejected, if any.

The output of this step is a visualized approval progress view presented to the user on the terminal.

### Step 14:

The user inputs comment information or additional information relating to the contract via the terminal.

The input to this step is the already displayed contract and approval status on the terminal.

The user types comments such as “Change the payment term to net 30 days” or attaches supporting documents, and the terminal packages these as structured comment information and additional information related to the contract identifier.

The output of this step is a new comment payload and additional data ready to be sent from the terminal to the server.

### Step 15:

The terminal transmits the comment information and additional information to the server for contract revision.

The input to this step is the comment payload and associated files generated on the terminal. The terminal sends this data to a designated server endpoint, including metadata such as user identifier and contract identifier, by forming a network request and uploading text and files in an agreed format.

The output of this step is a network request received by the server containing the user's comment information and additional information.

### Step 16:

The server stores the comment information and additional information and generates an additional input prompt sentence for revising the contract document data.

The input to this step is the received comment information, additional information, and the existing contract document data retrieved by contract identifier.

The server writes the comments and attachments to comment and file tables, then constructs an additional input prompt sentence that explicitly instructs the generative AI model on how to modify the contract, such as “Revise the following contract to change the payment term to net 30 days, without altering any other clauses. Contract text: [existing contract body].” The output of this step is stored feedback data and a formatted additional input prompt sentence for use with the generative AI model.

### Step 17:

The server submits the additional input prompt sentence and existing contract document data to the generative AI model to generate revised contract document data.

The input to this step is the additional input prompt sentence and the current contract text.

The server encodes the combined text into tokens, passes the tokens to the generative AI model with parameters controlling determinism and output length, and receives a revised text sequence where specific clauses have been updated according to the instructions.

The output of this step is revised contract document data in text form stored in server memory.

### Step 18:

The server integrates the revised contract document data into persistent storage and updates workflow information and approval state information if required.

The input to this step is the revised contract document text and existing workflow and approval state records.

The server creates a new version of the contract record, stores the revised text, evaluates revision impact rules to determine whether certain approvals must be reset, and updates workflow information and approval state information accordingly in the database.

The output of this step is an updated set of contract, workflow, and approval state records that reflect the new contract version and any necessary changes in approval requirements.

### Step 19:

The server performs sentiment analysis on user input information and generates sentiment information.

The input to this step is text data from user comments, prompt sentences, or other interactions stored in the system.

The server tokenizes the text, converts tokens into numerical embeddings, feeds them through a sentiment analysis neural network, calculates sentiment scores, and classifies each input into categories or continuous values representing emotional states; the server then stores these sentiment values associated with user and contract identifiers.

The output of this step is sentiment information recorded in a sentiment table or similar structure.

### Step 20:

The server adjusts instructions to the generative AI model and controls notification behavior based on the sentiment information.

The input to this step is the stored sentiment information combined with contract parameters and approval state information.

The server modifies system-level fragments of future prompt sentences to reflect preferred textual characteristics, such as clearer explanations or softer tone, and updates control parameters that define notification mode and notification frequency, for example by changing time intervals or channels; these modified parameters are then used in subsequent calls to the generative AI model and in notification scheduling.

The output of this step is updated prompt configuration data and updated notification control parameters that direct future text generation and communication behavior in the system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional contract management and approval systems primarily function as static document creation and workflow tools. In such systems, a processor generally assembles contract text from fixed templates or rule sets, and then routes the resulting documents through predefined approval flows. These systems face several technical problems when deployed in modern networked computing environments.

First, existing systems do not leverage generative AI models in a structured and controllable manner. Free-form use of generative AI often requires a human operator to manually craft prompt sentences, copy model outputs into separate applications, and manage versions by hand. As a result, the processor in a typical system spends computing resources on fragmentary, ad-hoc text generation workflows that are not integrated with data models, databases, or approval engines. This fragmentation leads to increased network traffic, redundant storage operations, and inconsistent document states across different components. Second, conventional systems treat user emotion and user comprehension as external factors that are not reflected in the internal data processing pipeline. User interfaces may display the same contract text regardless of whether the user is stressed, confused, or satisfied. From a computer-technical perspective, this means that the processor lacks a feedback loop connecting multimodal input signals (such as voice, image, and text) to the text generation pipeline. As a consequence, the system cannot automatically adapt prompt sentences or generate emotion-adapted contract versions in a way that optimizes processing steps, reduces repeated manual revisions, and minimizes unnecessary invocations of external services. Third, existing systems perform contract search and reporting using rigid query interfaces. A user must often translate a business-level question (for example, “contracts concluded in Q1 with high amounts”) into structured filters. Back-end components may generate raw database results but lack a mechanism to convert those results into natural-language summaries in a unified processing flow. Without a processor that can parse natural-language search inputs into search queries and then use those same parsed structures to drive generative summarization, the system incurs additional translation layers, duplicate parsing logic, and inefficient use of database and network resources.

Fourth, in face-to-face support scenarios, such as sales meetings assisted by wearable display devices, conventional architectures do not integrate visual identification, transaction history retrieval, and generative AI-based recommendation into a single control flow executed by the processor. Typically, distinct subsystems perform face recognition, history lookup, and recommendation generation with manual glue logic between them. This leads to latency, inconsistent caching, and an inability to coordinate prompt sentence generation, model calls, and display updates as a single optimized sequence of operations.

Fifth, many systems implement approval workflows and notification mechanisms as fixed-interval, one-size-fits-all processes. The processor sends follow-up messages at predetermined times, regardless of the actual approval state or the emotional state of the requesting user. This design wastes network and processing resources on unneeded notifications, while failing to increase notification frequency when the user is anxious about an approval. There is no mechanism for the processor to compute dynamic control information that ties approval states and emotion states to specific transmission frequencies and channels.

Accordingly, there is a need for a computer-implemented system in which a processor is configured to: (i) systematically generate and manage prompt sentences used with a generative AI model based on structured contract data, search conditions, and emotion signals; (ii) integrate emotion analysis into the text generation pipeline to create emotion-adapted document versions under explicit version management; (iii) parse natural-language search and concern expressions into both database queries and generative summarization prompts; (iv) orchestrate face-to-face support flows using subject identification information and transaction histories as inputs to prompt generation; and (v) dynamically control approval follow-up notifications based on approval and emotion states. Such a system improves the functioning of the computer itself by reducing redundant processing, decreasing the number of manual interactions required to adjust documents, normalizing prompt generation across subsystems, and coordinating database queries, generative AI calls, and user interface updates in a unified and optimized processing pipeline.

The specific processing by the specific processing unit 290 of the data processing device 12 in Application Example 2 is realized by the following means.

The present invention provides a server comprising a processor configured to parse information elements received from a user, generate structured prompt sentences to be input to a generative AI model based on an analysis result of the information elements, cause the generative AI model to generate or regenerate contract-related documents, convert generated documents into an electronic document format, manage versions of the documents, estimate an emotional state of the user based on multimodal input data, dynamically adjust wording characteristics of the documents and approval-related follow-up notifications based on the emotional state and an approval state, execute database queries for past contract-related data based on natural-language search inputs, generate prompt sentences for summarizing search results into natural-language expressions, process subject identification information from a face-to-face support display device to retrieve transaction history data, and generate prompt sentences for obtaining recommendation information and conversational guidance text for real-time presentation. This enables the server to orchestrate prompt sentence generation, generative AI model invocation, database access, emotion analysis, approval tracking, and user interface control as an integrated processing pipeline that reduces redundant operations, improves the efficiency and consistency of document generation and search summarization, adapts system behavior to user emotion and workflow context, and thereby enhances the overall performance and technical capabilities of the computer-implemented contract management and support system.

The term “processor” refers to a hardware processing circuit, such as a central processing unit, a microprocessor, or another computing element, that executes instructions to perform the described parsing, generation, analysis, control, and storage operations.

The term “information elements” refers to structured or unstructured data items obtained from a user, including but not limited to contract parameters, natural-language texts, search conditions, and configuration inputs that are subject to analysis by the processor.

The term “prompt sentence” refers to a machine-readable text string, typically in natural language, that encodes instructions, constraints, and contextual information for a generative AI model to generate or modify text or other content.

The term “generative AI model” refers to a software-implemented machine learning model, such as a neural network-based natural language generation model, that receives a prompt sentence and outputs generated text representing a contract-related document, a summary, a recommendation, or another natural-language expression.

The term “contract-related document” refers to any electronic representation of text that includes at least one provision, clause, or condition relating to an agreement, such as a confidentiality agreement, a sales agreement, a service agreement, or associated approval and explanatory documents.

The term “draft of a contract-related document” refers to a preliminary version of a contract-related document generated by the generative AI model before final confirmation, approval, or execution.

The term “electronic document format” refers to a digital file format suitable for storage, display, and editing by a computer system, such as a word processing format, a portable document format, or an equivalent structured format.

The term “user interface” refers to a hardware and software combination, including display components and input components, through which a user views generated content and provides operations such as editing, selection, and confirmation.

The term “voice information” refers to audio data acquired from a user, including speech signals and prosodic features, that can be processed to infer emotional or contextual characteristics.

The term “image information” refers to visual data acquired from a user, including still images and video frames representing a user's face, gestures, or posture, that can be processed to infer emotional or contextual characteristics.

The term “text information” refers to character-based data input or generated within the system, including natural-language sentences, phrases, and labels, that can be processed to infer emotional or contextual characteristics.

The term “emotion analysis algorithm” refers to a software procedure or model that processes at least one of voice information, image information, and text information to estimate an emotional state of a user, such as stress, confusion, satisfaction, or joy.

The term “emotional state” refers to an estimated psychological condition of a user, represented as one or more emotion categories and optionally associated scores, derived by applying the emotion analysis algorithm to multimodal input data.

The term “politeness” refers to a wording characteristic of a contract-related document, including tone, formality level, and indirectness, which can be increased or decreased by modifying phrases, honorifics, and explanatory expressions.

The term “amount of explanation” refers to a quantity and depth of descriptive or clarifying text within a contract-related document, which can be adjusted by adding, shortening, or elaborating explanatory clauses and comments.

The term “expression strength” refers to a degree of assertiveness, emphasis, or caution in the wording of a contract-related document, which can be adjusted by selecting stronger or weaker lexical and syntactic forms.

The term “emotion-adapted contract-related document” refers to a version of a contract-related document whose wording characteristics, including at least one of politeness, amount of explanation, and expression strength, are adjusted based on an estimated emotional state of a user.

The term “version management information” refers to data representing version identifiers, timestamps, relationships between versions, and associated metadata used to track and manage multiple versions of a contract-related document.

The term “history display” refers to a visual presentation of multiple versions of a contract-related document or associated events in chronological or logical order via the user interface.

The term “difference display” refers to a visual presentation highlighting changes between at least two versions of a contract-related document, such as insertions, deletions, or modifications, via the user interface.

The term “attribute information” refers to metadata associated with a contract-related document, including but not limited to contract type, monetary amount, department, risk level, and applicable policies, used for identifying related parties and controlling workflows.

The term “related parties” refers to entities, such as individuals, organizational units, or roles, that are associated with a contract-related document and that may be required to review, approve, or otherwise act upon the document.

The term “approval request information” refers to data specifying a request for an approval action, including contract identifiers, target related parties, deadlines, and required actions, which is generated and transmitted by the processor.

The term “approval state” refers to a representation of a current status of one or more approval requests, including states such as pending, approved, rejected, or requested for modification, along with associated timestamps and comments.

The term “follow-up notification” refers to a message transmitted to a user or an approver that reports, reminds, or inquires about the approval state or other workflow progress.

The term “control information” refers to parameters and rules computed by the processor for determining at least one of a frequency, timing, and method of transmitting follow-up notifications based on contextual data including approval states and emotional states.

The term “search conditions” refers to constraints or criteria derived from a user input, including time ranges, value thresholds, and attribute filters, used to construct a database query for past contract-related data.

The term “search query” refers to a structured request, such as a statement in a database query language, that is generated from search conditions and executed against a data store containing contract-related records.

The term “past contract-related database” refers to a data storage structure, implemented for example as relational tables or key-value stores, that maintains historical information about contract-related documents and associated metadata.

The term “natural language expression” refers to a human-readable text in a natural language, such as a summary, explanation, or status message, that is generated by the generative AI model based on provided data and prompt sentences.

The term “face-to-face support display device” refers to a terminal capable of being used in direct interaction with a subject, such as a head-mounted display, a handheld display, or another wearable or portable device that can present information in real time.

The term “subject identification information” refers to data that identifies or distinguishes a subject, such as an individual in a face-to-face setting, derived from sources including image analysis, device identifiers, or stored profile data.

The term “transaction history” refers to stored records of past interactions, such as purchases, agreements, or service usages, associated with a specific subject or counterpart entity.

The term “recommendation information” refers to generated data specifying one or more items, services, or actions suggested for a subject, based on at least the transaction history and contextual parameters.

The term “conversational guidance text” refers to natural-language text intended to guide a human operator in live communication with a subject, including suggested phrases, questions, or explanations.

The term “natural language search request sentence” refers to a user-provided sentence or phrase expressed in natural language that specifies a request to search for information, such as past contracts or transactions.

The term “concern expression sentence” refers to a user-provided sentence or phrase in natural language that expresses a concern, anxiety, or question about a status, such as recent payments or approvals.

The term “past payment information” refers to stored data describing historical payment events, including amounts, dates, statuses, and counterpart identifiers, which are used for verification and explanation.

The term “transaction information” refers to stored data describing historical transactions other than or in addition to payments, such as orders, deliveries, service engagements, or contract milestones.

The term “response sentence for reassurance” refers to a natural-language text generated to alleviate a user's concern by explaining that a status is normal or that issues have been resolved, based on verification results.

The term “response sentence for status explanation” refers to a natural-language text generated to objectively describe a current or past state of payments, approvals, or other transactions, based on verification results, without necessarily expressing reassurance.

The term “server” refers to one or more computing devices, which may be implemented as physical machines or virtual instances, that host at least the processor, memory, storage, and communication interfaces required to perform the described functions.

The term “user” refers to any human operator or client entity that interacts with the system via the user interface or the face-to-face support display device, including requesters, approvers, and operators in support or sales roles.

In an embodiment, a server, a terminal, and a user cooperate over a communication network to implement the claimed system. The server comprises at least one processor, a main memory, a non-volatile storage device, and a network interface. The terminal comprises at least one processor, a display, an input unit, and optionally a camera and a microphone. The user operates the terminal to supply information and to view and edit contract-related documents and support messages generated by the server.

The server executes application software including a contract management module, a prompt generation module, a generative AI interface module, an emotion analysis module, an approval workflow module, a database access module, and a user interface backend module. The server further executes a trained generative AI model stored in memory or accessed via an external inference service. The generative AI model is, for example, an auto-regressive neural language model based on a transformer architecture, including a plurality of self-attention layers, feed-forward layers, and layer normalization units. The model parameters are stored as floating-point weight matrices and bias vectors in the storage device and are loaded into memory for inference.

The server, in one embodiment, stores contract-related data in a relational database, such as a structured query language database, and stores versioned document contents in an object store, such as a file system or a key-value store. The database schema includes tables for contracts, contract versions, approval tasks, user profiles, emotion logs, and transaction histories. Each contract version record includes fields such as contract identifier, version number, timestamp, author identifier, and a reference to a document binary in the object store. Each emotion log record includes a user identifier, a timestamp, a set of emotion labels, and associated confidence scores.

The server, in one embodiment, analyzes user-provided text with a natural-language processing library, such as a syntactic parser and a named-entity recognizer, implemented for example in a software library of the type used for tokenization, part-of-speech tagging, and entity extraction. The server parses input text to extract information elements including party names, date ranges, monetary amounts, contract types, and jurisdiction names. These extracted elements are stored in structured internal data structures such as records or objects, which are later mapped directly into prompt sentences for the generative AI model. By using these structured data structures, the server avoids repeatedly parsing and re-normalizing the same content at later stages, thereby reducing computational overhead and improving consistency.

The terminal, in an embodiment, is implemented as a general-purpose computing device, such as a personal computer, a tablet, a smartphone, or a wearable head-mounted display. The terminal executes a user interface application implemented as a web application rendered by a browser or as a native application. The terminal sends user inputs, such as contract parameters, search queries, or concern expressions, to the server over a secure transport protocol. The terminal receives from the server rendered content or structured data and displays contract-related documents, approval status information, summaries, or recommendation messages in graphical user interface components.

The user, in normal operation, inputs contract parameters into the terminal, such as party identifiers, contract amounts, effective dates, and selected clause options. The user also inputs natural-language text, such as a request to search for past contracts or a statement of concern about recent payments. The user may further provide multimodal inputs, such as speech utterances captured by the microphone and facial expressions captured by the camera. The user then reviews the generated documents on the display, edits wording, approves or rejects drafts, and reads support or recommendation messages.

In an embodiment, the server generates a prompt sentence for the generative AI model by concatenating a fixed instruction template with dynamic information elements stored in structured data. For example, the server generates a prompt sentence:
“Using Japanese legal style, please draft a non-disclosure agreement with the following details: Disclosing party: Company A; Receiving party: Company B; Purpose: evaluation of technology; Term: 2 years; Governing law: Japan; Effective date: Feb. 1, 2026.”

The server feeds this prompt sentence, tokenized according to the vocabulary of the generative AI model, into the model. The generative AI model processes the tokens through a sequence of transformer layers. Each layer computes attention scores between tokens, multiplies token representations by learned weight matrices, and applies non-linear activation functions. The server obtains, at each time step, a probability distribution over next tokens, selects tokens according to a decoding strategy (for example, greedy decoding or top-k sampling), and constructs a generated text sequence representing a draft of a contract-related document.

The server, in another embodiment, generates a prompt sentence for adjusting wording based on emotion and existing draft text. For example, when the emotion analysis module indicates that the user is stressed, the server generates a prompt sentence:
“Rewrite the following contract so that it is easier to understand and more polite, for a user who is feeling stressed. Do not change the legal meaning. Contract text: [current contract clauses].”

The server again invokes the generative AI model with this prompt sentence and the current text. The generative AI model uses its attention mechanism to condition new output tokens not only on the original text but also on the instruction in the prompt sentence, resulting in an emotion-adapted contract-related document with increased politeness and additional explanatory wording. Because the prompt sentence is constructed programmatically from structured data and emotion labels, the process can be repeated consistently for different users and contexts without human intervention in prompt crafting.

The server, in an embodiment, performs emotion estimation by executing an emotion analysis algorithm. The emotion analysis algorithm includes one or more neural networks, such as a convolutional neural network for facial expression classification and a recurrent or transformer-based network for speech prosody classification. The server, or in some cases the terminal, extracts features from raw signals, including mel-frequency cepstral coefficients from audio and facial landmark coordinates from images. These feature vectors are passed through the neural networks, which have been trained by supervised learning using labeled datasets where each sample is annotated with target emotions. During training, the networks minimize a loss function, such as cross-entropy between predicted emotion distributions and ground-truth labels, by updating weights with gradient descent and back-propagation. During inference, the networks output probabilities for emotion categories, such as stress, joy, confusion, and satisfaction. The server then stores the highest-probability label and the distribution in the emotion log.

The server, in an embodiment, uses the emotion log together with approval state information in the approval workflow module. The approval workflow module maintains state machines for each contract, with states such as pending, in review, approved, and rejected. The server computes follow-up notification schedules based on both the state machine and the emotion log. For example, when the approval state is pending and the emotion log shows repeated stress entries for the requesting user, the server reduces the interval between notifications or selects a more immediate communication channel, such as in-application alerts instead of email. Conversely, when the user emotion indicates satisfaction and the approval state is stable, the server increases intervals, thereby reducing network traffic and processing load. The server computes these schedules by applying deterministic rules stored in configuration tables or by using a secondary model that maps input features (approval state, elapsed time, emotion scores) to control information (notification frequency, channel type). The server, in an embodiment, parses natural-language search request sentences into structured search conditions. The server uses tokenization, syntactic parsing, and entity recognition to extract date ranges, numerical thresholds, and contract types from text such as “I want to see all contracts signed in the first quarter of 2022 with amounts greater than ten million yen.” The server then generates an internal intermediate representation, such as a tree of filter conditions, and then translates this into a database query, such as a structured query language statement. Because the server stores contracts with normalized fields for dates, amounts, and types, the generated query can be executed efficiently using indexes. The query results are stored in a result set structure, which is then passed to the prompt generation module.

The server, in another embodiment, generates a summarization prompt sentence for the generative AI model by embedding the result set into a textual description. For example, the server generates:
“Please take the following contract records and generate an easy-to-understand English summary for a business user. Focus on number of contracts, key counterparties, total and average amounts, and main expiration dates. Records: [tabular data].”

The generative AI model, when given this structured prompt, produces a natural-language expression summarizing the contents of the result set. By reusing the same parsing and prompt generation mechanisms for both contract drafting and summarization, the system maintains a unified prompt management framework, reducing software duplication and ensuring consistent behavior across modules.

The server, in an embodiment, supports a face-to-face support display device, such as smart glasses used by a salesperson. The terminal in this case comprises a camera and a near-eye display. The terminal captures images of a subject and sends them to the server. The server executes a face recognition algorithm, which may be a convolutional neural network trained on facial embeddings. The server computes an embedding vector for the captured face and compares it to stored embeddings in a subject database using distance metrics, such as cosine similarity. When a match exceeds a threshold, the server retrieves a subject identifier and uses it to query a transaction history table.

The server, in this embodiment, generates a recommendation prompt sentence by combining transaction history data with a fixed instruction. For example:
“Based on this customer's past purchases of premium red wine priced above 10,000 yen per bottle, suggest the next product to propose and provide a short sales pitch in Japanese that a salesperson can say aloud during a face-to-face conversation.”

The generative AI model returns a recommended product and a conversational guidance text, which the server formats into short bullet points and sends back to the smart glasses. The display shows key phrases within a limited character count, enabling the salesperson to read them quickly. This integration of visual recognition, database retrieval, and generative text creation in a single orchestrated data flow reduces latency and improves the technical performance of the real-time support system.

The server, in another embodiment, processes concern expression sentences relating to payments or approvals. For example, when the user enters:
“I am worried about my recent payments.”

the server uses a sentiment classifier, which may be implemented as a transformer-based text classifier trained on labeled concern data, to detect an anxiety-related emotion. The server then issues a database query to a payment history table to verify the status of recent transactions. After obtaining a structured verification result, the server generates a prompt sentence for the generative AI model:
“The user wrote ‘I am worried about my recent payments.’ Their last ten payments were processed successfully, with no late fees or errors. Generate a short, empathetic reassurance message suitable for customer support chat.”

The generative AI model then outputs a response sentence for reassurance. The server sends this message to the terminal, and the terminal displays it in a chat interface. In this manner, the server combines deterministic verification logic with learned generative capabilities, ensuring factual correctness while leveraging flexible language generation.

The server, in an embodiment, improves computer-technical performance when compared with conventional systems. Because the server represents information elements in a structured internal format and programmatically constructs prompt sentences, the server reduces redundant parsing and manual manipulation of text, lowering CPU usage and memory allocations. The server further caches intermediate representations, such as parsed search conditions and transaction history summaries, which can be reused when generating multiple related prompt sentences. As a result, fewer calls to the generative AI model are needed when small changes occur, improving overall throughput.

The server also reduces communication overhead by coupling approval state tracking with emotion-based notification scheduling, as described above. This coupling leads to fewer unnecessary notifications transmitted over the network, which reduces bandwidth consumption and server load. Additionally, by using the generative AI model to generate both initial drafts and emotion-adapted revisions in a coordinated manner, the server eliminates repeated manual editing cycles, lowering the total number of data transmissions and document updates.

The generative AI model, in one training embodiment, is trained using a corpus of contract texts and associated instructions. The training procedure includes sampling pairs of prompt sentences and target texts, computing cross-entropy loss between predicted token distributions and ground-truth tokens, and updating model weights with stochastic gradient descent and an optimizer such as Adam. The system may further apply fine-tuning on specialized datasets, such as emotion-conditioned rewrites or summarization of contract tables, to improve precision in the target domain. Data augmentation techniques, such as synonym substitution or template-based paraphrasing, may be used to increase robustness. These design and training choices lead to lower error rates in clause generation and more reliable adherence to constraints expressed in prompt sentences, improving the accuracy of generated documents.

The server, in various embodiments, may host the generative AI model locally or may communicate with an external inference server via application programming interfaces. In either case, the server manages tokenization, batching of requests, and timeout handling to maintain efficient processing. The server may aggregate multiple prompt sentences into a batch for processing by the generative AI model, reducing overhead and improving GPU utilization when a hardware accelerator is available.

In alternative embodiments, the terminal may perform some of the parsing or emotion analysis locally. For instance, a smartphone terminal may execute a lightweight emotion classifier on captured facial images and send only emotion labels and confidence scores to the server, reducing transmission of raw video data and thereby preserving bandwidth and privacy. A wearable device may implement pre-processing operations, such as down-sampling or feature extraction, before uploading features to the server. These variations demonstrate that the system is not limited to a single deployment pattern but remains grounded in specific hardware and software components.

In another embodiment, the server may employ different database technologies, such as a document-oriented store for storing versioned documents and a column-oriented store for analytical queries on contract metadata. The database access module may choose an appropriate data store based on query patterns, further improving query performance and resource utilization. The server may maintain materialized views of frequently requested aggregates, such as counts and totals by quarter, which are directly embedded into prompt sentences for summary generation, reducing latency.

In yet another embodiment, the server applies rule-based pre-filters to generated text in order to enforce syntactic or semantic constraints. For example, the server may detect missing mandatory clauses by scanning generated contracts for required keywords and may automatically generate a prompt sentence instructing the generative AI model to add or correct such clauses. This non-conventional combination of learned generation and rule-based verification reduces the risk of omissions and improves the technical robustness of the system.

Through these configurations, the server, the terminal, and the user interact with concrete data structures, algorithms, and hardware components. The system does not merely automate a human mental process but instead implements specific computational techniques-structured prompt management, multimodal emotion analysis, dynamic workflow control, and integrated database-driven summarization and recommendation—that improve processing efficiency, accuracy, and resource usage of the underlying computer system.

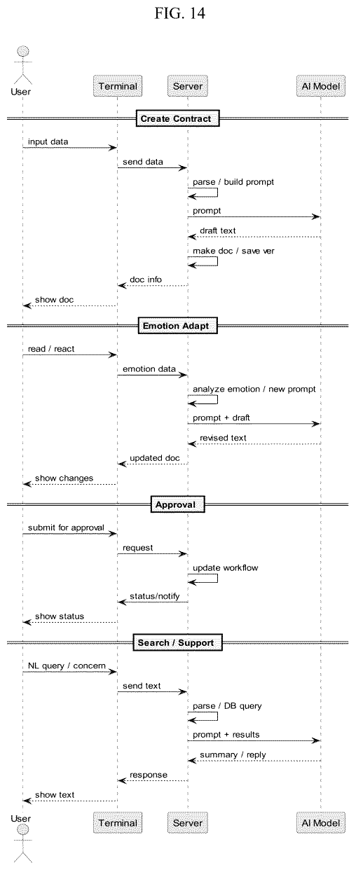

The following describes the processing flow using FIG. 14.

### Step 1:

User operates the terminal to start a contract task and inputs initial information.

User selects a function on the terminal, such as “Create new contract,” “Search past contracts,” or “Check approval status,” and then enters information including party names, contract type, amounts, dates, and any free-text notes.

Input: raw user input (form fields and natural-language text) on the terminal.

Output: structured input data (for example, JSON with typed fields) held in the terminal.

Terminal converts free-text and form values into a structured object, performs basic validation (type checking, required fields), and prepares a data packet for transmission.

### Step 2:

Terminal transmits structured user input to the server.

Terminal sends the structured input data to the server over a secure communication channel using a request message that includes a user identifier, operation type, and payload.

Input: structured input data at the terminal.

Output: request message delivered to the server.

Terminal serializes the data, attaches authentication tokens, and invokes a network stack to send the message to a predefined server endpoint.

### Step 3:

Server parses received user input and generates internal information elements.

Server receives the request message, validates the message format and authentication, and extracts the structured input payload.

Input: request message from the terminal.

Output: internal information elements (normalized contract parameters, search conditions, or concern expressions) stored in server memory.

Server uses parsing routines and, for free-text fields, natural-language processing components to extract entities such as dates, amounts, contract categories, and counterpart identifiers, then stores them in typed structures, such as records or objects.

### Step 4:

Server decides the processing type and configures subsequent modules.

Server analyzes the operation type indicator (for example, create, modify, search, support, recommend) and selects appropriate processing paths, such as contract drafting, summarization, or reassurance message generation.

Input: internal information elements and operation type.

Output: control parameters specifying which modules to execute (prompt generation, database access, emotion analysis, workflow control).

Server sets flags and parameters in a control structure that guides later function calls and data flows.

### Step 5:

Server constructs a base prompt sentence for the generative AI model.

Server uses a prompt template corresponding to the selected operation and fills in placeholders with the internal information elements.

Input: internal information elements and a prompt template.

Output: base prompt sentence in natural-language text.

Server performs string concatenation and substitution, normalizes values (for example, date formatting), and generates text such as: “Using Japanese legal style, please draft a non-disclosure agreement with the following details: . . . ”.

### Step 6:

Server, when needed, queries the database to gather supplementary data.

Server determines whether supplementary data, such as past contracts, payment histories, or transaction histories, is required for the task and, if so, issues database queries.

Input: internal information elements and control parameters.

Output: retrieved records (for example, contract rows, transaction rows) stored in result sets.

Server uses structured query language statements or API calls, applies filters extracted from the information elements (such as date ranges and thresholds), and loads the resulting data into in-memory collections.

### Step 7:

Server embeds supplementary data into the prompt sentence.

Server converts the retrieved records into a textual or tabular representation and appends or integrates this representation into the base prompt sentence.

Input: base prompt sentence and supplementary data records.

Output: enriched prompt sentence containing both instructions and data context.

Server formats the records into readable lines or a structured table, then concatenates this text to the instruction portion of the prompt sentence to produce prompts such as: “Please take the following contract records . . . Records: [tabular data].”

### Step 8:

Server performs emotion analysis when multimodal data or concern text is available.

Server, upon receiving user voice, image, or concern expression text, executes emotion analysis algorithms to estimate an emotional state.

Input: multimodal user data (audio features, image features, text) and optionally previous emotion logs.

Output: estimated emotional state with labels and scores stored in an emotion log. Server applies pre-trained neural network models to feature vectors, computes emotion probabilities, selects top labels (such as stress or satisfaction), and records results alongside timestamps and user identifiers.

### Step 9:

Server adjusts the prompt sentence based on the emotional state.

Server uses the emotional state to decide whether wording, tone, or explanation level should be adapted and modifies or extends the prompt sentence accordingly.

Input: base or enriched prompt sentence and emotional state information.

Output: emotion-adapted prompt sentence specifying wording adjustments.

Server inserts clauses into the prompt, for example adding constraints such as: “Rewrite the following contract so that it is easier to understand and more polite, for a user who is feeling stressed. Do not change the legal meaning.”

### Step 10:

Server sends the final prompt sentence to the generative AI model and requests generation.

Server tokenizes the final prompt sentence according to the model's vocabulary, constructs a model input batch, and sends this to a generative AI model execution environment.

Input: emotion-adapted prompt sentence and optionally current document text or data summaries.

Output: generated output sequence from the generative AI model.

Server manages the call by setting inference parameters (for example, maximum length, temperature), sending the request, and waiting for a response containing generated tokens.

### Step 11:

Server decodes and post-processes the generated output.

Server converts generated tokens back into text, verifies completeness, and optionally applies rule-based checks (such as presence of mandatory clauses or field values).

Input: generated token sequence from the generative AI model.

Output: generated text (contract draft, summarized report, recommendation, or reassurance message) stored in server memory.

Server concatenates tokens into text strings, removes invalid characters, and may apply deterministic corrections, such as normalizing numbering or headings.

### Step 12:

Server, when generating or revising a contract-related document, converts text to an electronic document format.

Server maps the generated text into a structured document representation and writes it to a file format suitable for editing and viewing.

Input: generated contract-related text.

Output: document file (for example, word-processing or portable document format) and a corresponding version record.

Server creates a document structure with sections, paragraphs, and styles, assigns a new version identifier, and stores the file in an object store with a record linking the contract identifier and the version.

### Step 13:

Server updates version management information and stores emotion and context metadata.

Server records the new document version, emotional state, and any generation context (such as prompt content and model parameters) in the database.

Input: new document file, generated text, emotional state, and context data.

Output: updated version management entries and emotion log entries.

Server writes to contract version tables, associating version numbers with timestamps and user identifiers, and updates emotion logs to allow later retrieval and analysis.

### Step 14:

Server prepares a response payload and sends it to the terminal.

Server packs references to generated or revised documents, summary text, recommendation text, or reassurance messages into a structured response and transmits it to the terminal.

Input: generated outputs and metadata.

Output: response message for display or further interaction on the terminal.

Server may include document preview snippets, status flags, and routing instructions in the response payload.

### Step 15:

Terminal receives the response and renders content for the user.

Terminal parses the response, retrieves document files or text, and displays the content in appropriate user interface components, such as editors, summary panels, or notification banners.

Input: response message from the server.

Output: on-screen graphical presentation of documents, summaries, or messages.

Terminal renders text, applies highlighting or change indicators, and provides controls for editing, approving, or acknowledging content.

### Step 16:

User reviews and optionally edits generated contract-related documents or messages.

User reads the displayed content, scrolls through sections, and, if permitted, modifies wording, adds comments, or selects actions such as “Submit for approval” or “Request revision.”

Input: displayed content on the terminal.

Output: updated content (if edited) and user commands.

Terminal detects edits and command selections, updates local representations, and prepares new request messages reflecting the user's changes or decisions.

### Step 17:

Terminal sends updated content or commands to the server.

Terminal transmits edited text, selected actions, or approval decisions back to the server in structured messages.

Input: updated content and user commands.

Output: server-bound messages including revised text or workflow actions.

Terminal serializes new data, attaches identifiers for affected contracts or tasks, and sends the data over the network.

### Step 18:

Server updates approval workflow states based on user or approver actions.

Server receives commands indicating submission for approval, approval, rejection, or change requests, and updates the approval task records accordingly.

Input: workflow action messages from the terminal.

Output: modified approval state records and, when necessary, new approval tasks.

Server applies state transition rules, logs decisions, and may generate subsequent tasks or notifications for other approvers.

### Step 19:

Server computes follow-up notification control information using approval and emotion data.

Server combines the current approval state and recent emotional state logs to determine timing and channels for follow-up notifications.

Input: approval state records and emotion logs.

Output: control information specifying notification frequency, channel, and recipients.

Server executes rules or a model that maps state and emotion features into temporal intervals and communication modes and stores this control information for scheduling.

### Step 20:

Server sends follow-up notifications to the terminal according to computed control information.

Server generates notification messages that describe approval progress or pending actions and transmits them to terminals at computed times through appropriate channels.

Input: control information and workflow status data.

Output: notification messages delivered to terminals.

Server uses messaging subsystems (for example, push services or WebSocket connections) to send alerts that include status summaries and links to relevant documents.

### Step 21:

Terminal displays follow-up notifications and allows the user to respond.

Terminal receives notifications, shows them as banners, dialogs, or list items, and offers actions such as opening the detailed view, acknowledging the notification, or sending a follow-up inquiry.

Input: notification messages from the server.

Output: updated user interface state and optional user responses.

Terminal logs user interactions and can trigger further messages to the server when the user chooses to act.

### Step 22:

User initiates search or support inquiries using natural-language text.

User types queries like “I want to see all contracts signed in Q1 2022” or concern statements like “I am worried about my recent payments” into the terminal interface.

Input: user-entered natural-language sentences.

Output: structured request objects containing the text and context tags.

Terminal encapsulates the text, attaches identifiers, and sends the request to the server for analysis.

### Step 23:

Server processes natural-language search or concern expressions and generates corresponding prompts.

Server parses search or concern sentences, extracts conditions or topics, and, when needed, queries databases to obtain factual data.

Input: natural-language request sentences and internal data stores.

Output: search results and factual verification data, plus prompt sentences tailored for summarization or reassurance.

Server computes search queries from the parsed structure, executes them, then composes prompt sentences such as: “Summarize the following contract records . . . ” or “Generate a short, empathetic reassurance message . . . ” using both the original user text and the verification results.

### Step 24:

Server invokes the generative AI model to produce summaries, recommendations, or reassurance messages.

Server sends these prompt sentences and supporting data to the generative AI model and receives generated natural-language responses.

Input: prompt sentences and, when applicable, structured data.

Output: generated summaries, recommendations, or support messages.

Server decodes the output, checks for completeness, and stores the responses for delivery. Step 25:

Terminal presents generated summaries, recommendations, or reassurance messages to the user.

Terminal displays the generated text in appropriate views, such as summary panels for search, overlays on smart glasses for recommendations, or chat bubbles for reassurance.

Input: generated text responses from the server.

Output: visual presentation of the responses and potential further user actions (for example, selecting a recommended item or acknowledging a reassurance message).

Terminal updates the interface state and enables the user to continue interacting with the system, thereby closing the processing loop.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

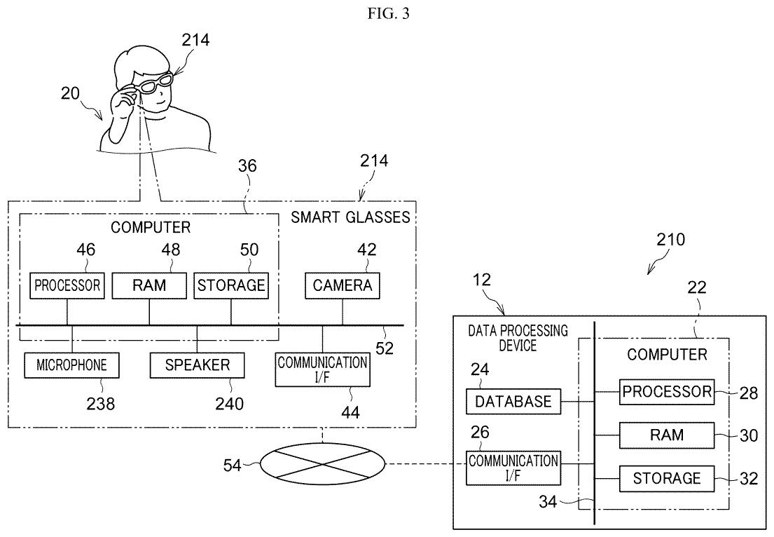

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

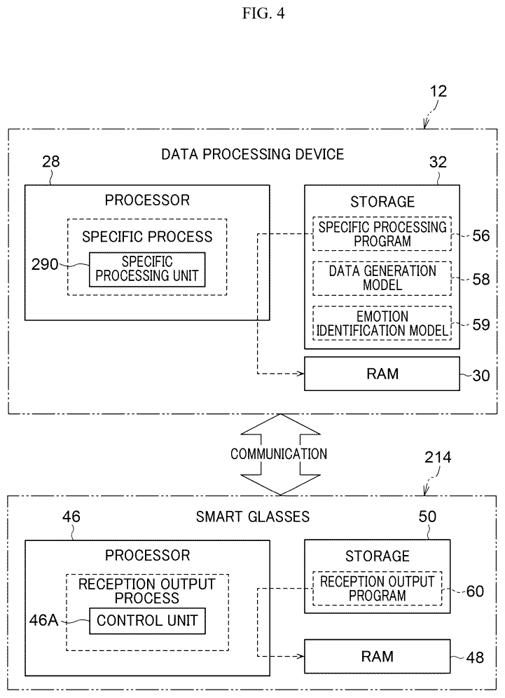

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

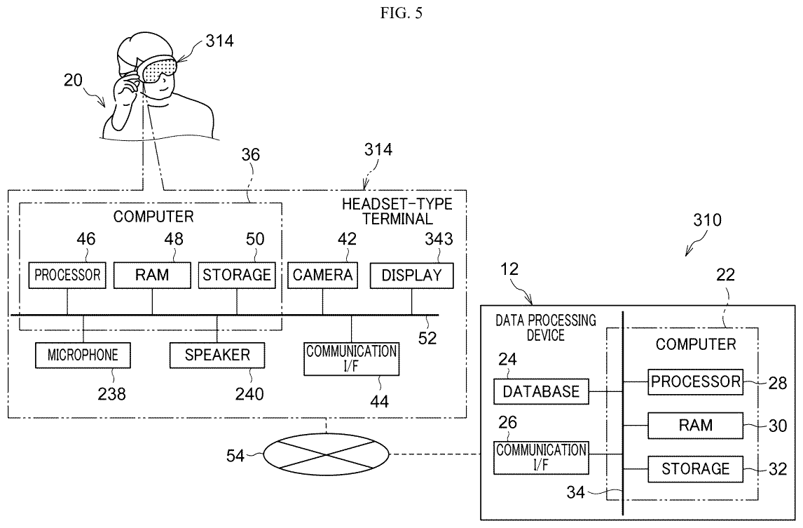

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

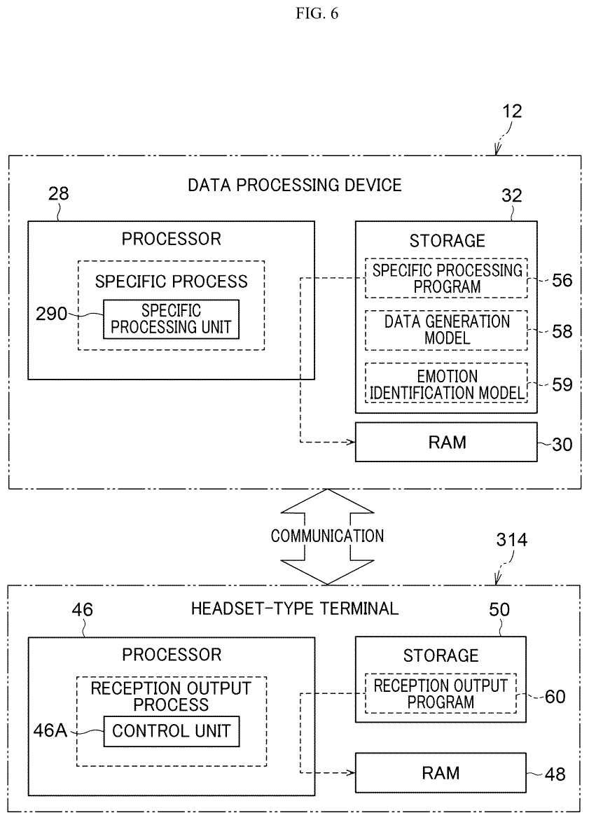

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

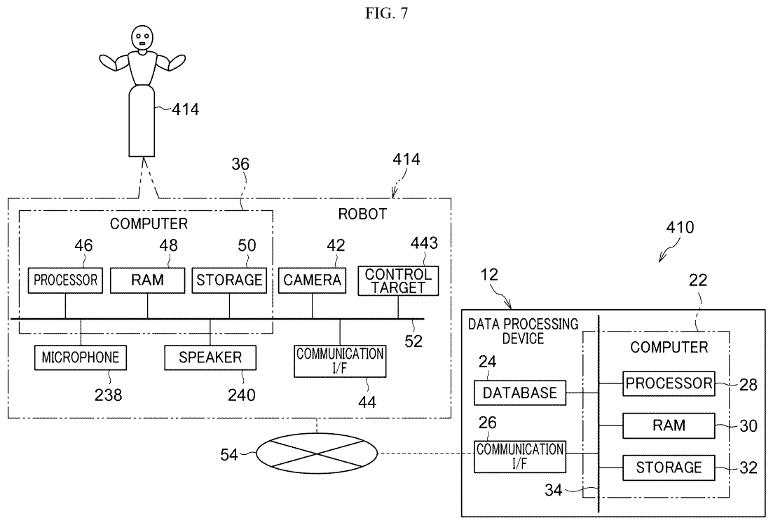

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

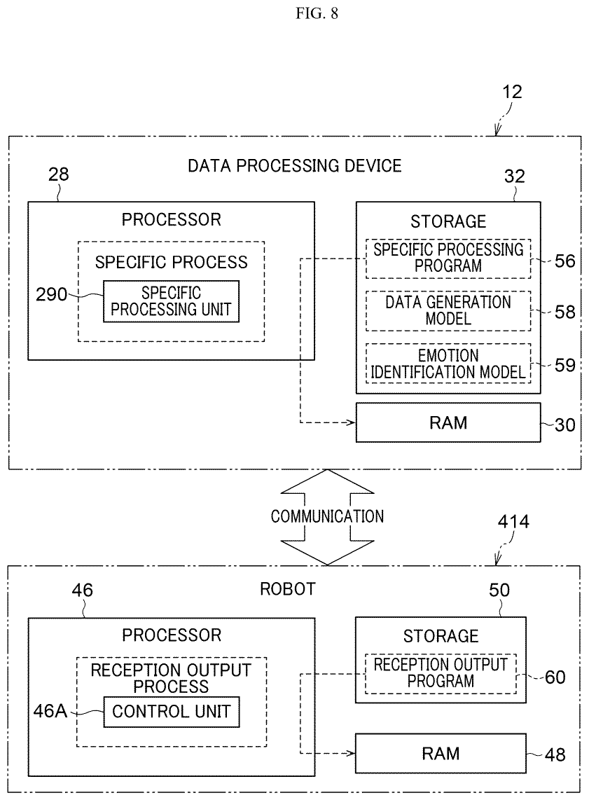

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

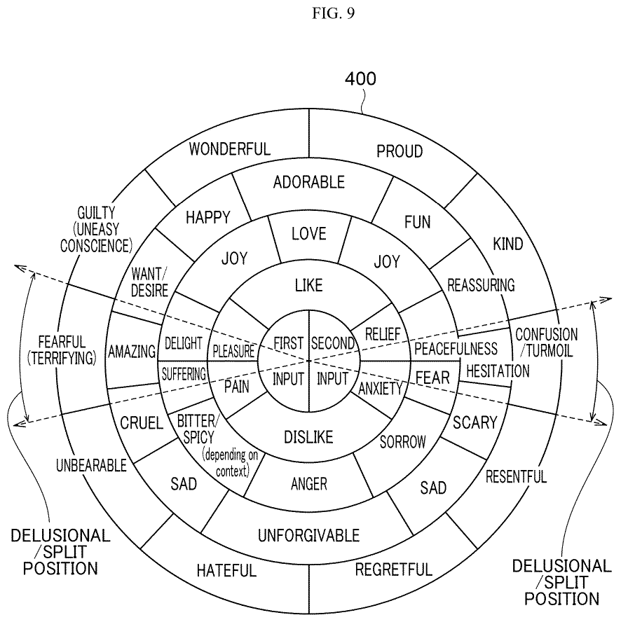

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

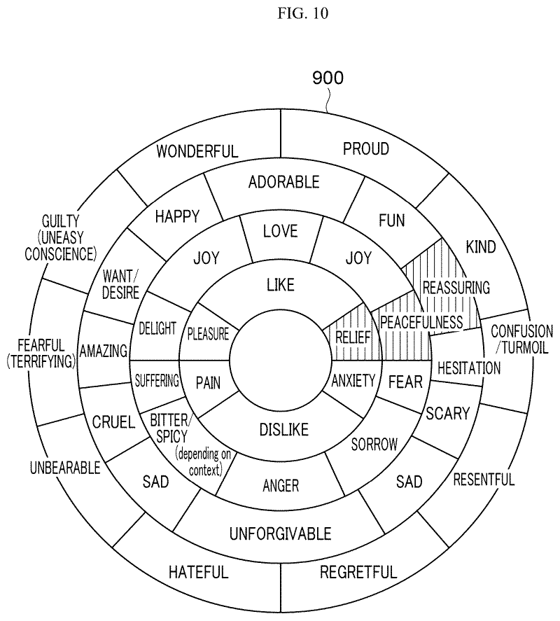

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
analyze contract information acquired from a user terminal and extract purpose information, party information, period information, and contract type information included in the contract information; and
construct a prompt sentence for instructing a generative AI model to generate a contract document draft based on the extracted contract information, and provide input data including the prompt sentence and the contract information to the generative AI model so as to cause the generative AI model to generate the contract document draft; and
post-process text data output from the generative AI model and convert the text data into document structure data to which heading information, clause information, and format information are assigned; and
generate electronic document data conforming to a predetermined document file format based on the document structure data, store the electronic document data in a file storage device, and register the contract information and metadata associated with the electronic document data as search information in an index database; and
transmit the electronic document data to the user terminal via a user interface and provide the electronic document data in a state in which the electronic document data can be displayed and edited on the user terminal; and
acquire, from the user terminal, an additional prompt sentence or a correction instruction, re-input the additional prompt sentence and a part of the electronic document data into the generative AI model to generate an updated contract document draft in which a specific clause is modified, and update the electronic document data based on the updated contract document draft; and
acquire, from the user terminal, a search condition relating to past contract information, search the index database based on the search condition to extract related contract document information, and provide a result of the extraction to the user terminal to reduce a load of information retrieval; and
execute emotion analysis processing on user input information to calculate emotion information, and adjust at least one of tone, expression strength, and follow-up operation condition of the prompt sentence or the contract document draft based on the emotion information.

### (Supplementary 2)

The system according to supplementary 1,
wherein the processor is configured to
use, as the generative AI model, a model that executes generation processing targeting at least part of a contract conclusion clause relating to at least one of a confidentiality contract, a sales transaction contract, and a use license contract, and include the contract type information and a generation condition relating to the contract conclusion clause in the prompt sentence.

### (Supplementary 3)

The system according to supplementary 1,
wherein the processor is configured to
generate a prompt sentence including an instruction to dynamically change at least one of a notification frequency, a notification method, and message content of a progress management operation relating to an approval request, in accordance with the emotion information, and output to the user terminal a follow-up message created by the generative AI model based on the prompt sentence.

### Application Example 1

### (Supplementary 1)

A system comprising a processor,
wherein the processor is configured to
receive, via a user interface, contract-related information input by a user, and generate structured data including the contract-related information,
construct a prompt sentence for a generative AI model based on the structured data, transmit a generation request including the prompt sentence to the generative AI model, and obtain, from the generative AI model, natural language text as a draft of a contract document, analyze the natural language text to divide the natural language text into contract clause units and generate document structure data including headings and clause numbering,
embed the document structure data into a predetermined document template, and generate a contract document file in an electronic document format,
display, via the user interface, at least one of the contract document file and the natural language text so that the user can review and edit the contract document, accept an editing operation from the user, and reflect an editing result in the contract document file,
accept, via the user interface, an electronic signature request for the contract document file, calculate a hash value of the contract document file by using a cryptographic algorithm, generate electronic signature data for the hash value by using a secret key, and embed the electronic signature data into the contract document file,
store contract management data including the contract-related information and version information of the draft of the contract document in a storage, and index the contract management data so that past contract documents are searchable,
receive, via the user interface, a search condition for the indexed contract management data, extract, based on the search condition, at least one past contract document as a search result, generate a new prompt sentence based on the at least one past contract document and the structured data, and cause the generative AI model to regenerate a new draft of a contract document based on the new prompt sentence, and
apply an emotion analysis algorithm to input information from the user to estimate an emotional state of the user, and adjust at least one of the prompt sentence and the natural language text of the draft of the contract document according to the estimated emotional state

### (Supplementary 2)

The system according to supplementary 1,
wherein the processor is configured to
include, in the prompt sentence, section information indicating at least one contract execution section selected from a confidentiality-related section, a resale-related section, a terms-of-use-related section, and another specific contract execution section, together with the structured data, and cause the generative AI model to generate the draft of the contract document including the at least one contract execution section.

### (Supplementary 3)

The system according to supplementary 1,
wherein the processor is configured to
add control information to the prompt sentence according to the emotional state of the user estimated by the emotion analysis algorithm, the control information being used to dynamically change at least one of a frequency, a method, and an expression content of notification processing related to a decision-making request, and cause the generative AI model to generate a follow-up text for the notification processing based on the prompt sentence including the control information.

### Example 2

### (Supplementary 1)

A system comprising a processor,
wherein the processor is configured to
analyze contract-related information including input information acquired from a user terminal, and generate a prompt sentence for instructing a generative AI model to generate a contract document on the basis of a result of the analysis and predetermined document generation conditions,
output contract document data acquired from the generative AI model as document-format data, cause the document-format data to be displayable via a user interface, and accept viewing and editing operations by a user,
analyze text data including the contract document data, and extract structured information including amount information, period information, counterpart information, region information, and contract type information,
automatically generate workflow information representing an approval request flow, by specifying required approval entities, an approval order, and an approval scheme on the basis of the structured information and predetermined approval condition information and approval route information,
generate approval request tasks on the basis of the workflow information, transmit notification information corresponding to the approval request tasks via a communication unit, manage approval state information, and thereby automatically control progress of the approval request flow,
acquire the approval state information and the workflow information, and generate display data enabling real-time presentation of progress status of the approval request flow to the user terminal as status information,
generate an additional input prompt sentence for revising the contract document data on the basis of comment information or additional information acquired from the user, cause the generative AI model to generate revised contract document data again, and update the workflow information and the approval state information in accordance with the revised contract document data, and
analyze user input information by using a sentiment analysis algorithm, generate sentiment information, modify contents of instructions to the generative AI model so as to adjust textual characteristics of the contract document data on the basis of the sentiment information, and generate control information for dynamically adjusting a notification mode or notification frequency of the approval state information.

### (Supplementary 2)

The system according to supplementary 1,
wherein the processor is configured to
generate, by using the generative AI model, a prompt sentence for instructing generation of a plurality of types of documents for contract conclusion including a nondisclosure agreement, a resale master agreement, a sales agreement, and a license agreement, dynamically in accordance with the structured information including the contract type information and the amount information, and to associate generation of the prompt sentence with generation of the workflow information.

### (Supplementary 3)

The system according to supplementary 1,
wherein the processor is configured to
generate control information for changing a transmission timing, a transmission route, and message contents of follow-up notifications in the approval request flow on the basis of the sentiment information and the approval state information, and automatically update transmission conditions of the notification information on the basis of the control information.

### Application Example 2

### (Supplementary 1)

A system comprising a processor,
wherein the processor is configured to
parse information elements acquired from a user and generate a prompt sentence to be input to a generative AI model, the prompt sentence instructing the generative AI model to generate a draft of a contract-related document based on an analysis result of the information elements,
convert the draft of the contract-related document acquired from the generative AI model into an electronic document format, display the contract-related document in the electronic document format via a user interface, and accept an editing operation by the user,
acquire at least one of voice information, image information, and text information of the user, and estimate an emotional state of the user by analyzing the acquired information using an emotion analysis algorithm,
generate, based on the emotional state of the user and the draft of the contract-related document, a prompt sentence for adjusting at least one of politeness, amount of explanation, and expression strength of wording of the contract-related document, and cause the generative AI model to regenerate an emotion-adapted contract-related document by inputting the prompt sentence and the draft of the contract-related document to the generative AI model,
store the regenerated contract-related document in association with version management information, and perform at least one of history display and difference display based on the version management information via the user interface,
identify related parties based on attribute information assigned to the contract-related document, generate approval request information for each of the related parties, notify the approval request information, and record an approval state so as to track progress of an approval request,
generate control information for dynamically changing at least one of a transmission frequency and a transmission method of a follow-up notification relating to the approval request based on the approval state and the emotional state of the user, and transmit the follow-up notification based on the control information,
parse a user input including search conditions for a past contract-related database, generate a search query based on the analysis result, search the past contract-related database by using the search query, and input to the generative AI model a prompt sentence for generating a natural language expression that summarizes or explains a search result,
display, via the user interface, the natural language expression acquired from the generative AI model in association with the search result, and
acquire subject identification information from a face-to-face support display device, search a transaction history relating to a subject based on the subject identification information, input to the generative AI model a prompt sentence for generating recommendation information and conversational guidance text for the subject based on the transaction history, and present a generation result of the generative AI model to the face-to-face support display device.

### (Supplementary 2)

The system according to supplementary 1,
wherein the processor is configured to cause the prompt sentence input to the generative AI model to include an instruction to generate or modify the contract-related document including clause candidates of at least one of a confidentiality agreement, a sales agreement, and a service agreement, and to include wording adjustment conditions based on at least one of the emotional state of the user, the transaction history, and the approval state.

### (Supplementary 3)

The system according to supplementary 1,
wherein the processor is configured to parse at least one of a natural language search request sentence and a concern expression sentence received from the user, generate a search query for verifying at least one of past payment information and transaction information based on an analysis result of the sentence, and input to the generative AI model a prompt sentence for generating a response sentence for at least one of reassurance and status explanation based on a verification result, and present a generation result of the generative AI model via the user interface.

What is claimed is:

1. A system comprising:
circuitry configured to:
receive, via a communication interface coupled to a packet-switched network, structured input data from a terminal device, and extract, by applying a natural language processing model to the structured input data, a purpose identifier, a party identifier, a period parameter, and a type identifier;
construct a prompt sentence encoding the purpose identifier, the party identifier, the period parameter, and the type identifier, and input the prompt sentence and the structured input data to a generative neural network model to obtain text output data;
post-process the text output data to assign heading information, clause information, and format information to segments of the text output data, and generate electronic document data conforming to a predetermined document file format based on the post-processed text output data;
store the electronic document data in a storage device, and register the purpose identifier, the party identifier, the period parameter, the type identifier, and metadata associated with the electronic document data as search information in an index database;
transmit the electronic document data to the terminal device via the communication interface so that the electronic document data is displayable and editable at the terminal device;
execute emotion analysis processing on user input information received from the terminal device to calculate emotion information, and adjust at least one of a tone parameter, an expression strength parameter, or a follow-up condition of the prompt sentence based on the emotion information; and
acquire, from the terminal device, a correction instruction, re-input a corrected prompt sentence incorporating the correction instruction and at least a portion of the electronic document data into the generative neural network model to obtain updated text output data, and update the electronic document data based on the updated text output data.

2. The system according to claim 1, wherein the circuitry is configured to extract the purpose identifier, the party identifier, the period parameter, and the type identifier by tokenizing the structured input data, applying a named entity recognition model to identify entity spans, and mapping the identified entity spans to structured attribute fields.

3. The system according to claim 2, wherein the circuitry is configured to post-process the text output data by applying a structural parsing algorithm to detect clause boundaries and heading markers, assigning each detected segment a clause identifier and a heading level, and constructing a document tree representation that maps each segment to a position in the predetermined document file format.

4. The system according to claim 2, wherein the structured input data comprises contract information specifying terms of a legal agreement, the purpose identifier comprises a contract purpose field, the party identifier comprises a contracting party field, and the type identifier specifies a document type selected from a plurality of predetermined document categories.

5. The system according to claim 4, wherein the circuitry is configured to generate the electronic document data in a document file format that is directly editable at the terminal device, and to output the electronic document data for display via a user interface that allows the user to review and modify individual clauses of the electronic document data.

6. The system according to claim 1, wherein the circuitry is configured to execute the emotion analysis processing by applying an emotion analysis algorithm to at least one of text input, voice input, or interaction timing data received from the terminal device to compute the emotion information as a multi-dimensional emotional state vector.

7. The system according to claim 6, wherein the circuitry is configured to apply an emotion identification model to the at least one of text input, voice input, or interaction timing data to output a probability distribution over a plurality of emotional state categories, and to select the tone parameter, the expression strength parameter, or the follow-up condition based on a mapping between the probability distribution and predefined adjustment rules.

8. The system according to claim 6, wherein the circuitry is configured to adjust the follow-up condition by modifying a notification frequency parameter and a notification timing parameter of an approval follow-up workflow based on the emotional state vector, such that a higher urgency emotional state increases the notification frequency parameter.

9. The system according to claim 1, wherein the circuitry is configured to acquire, from the terminal device, a search condition relating to prior document information, search the index database using the search condition to retrieve related document records, and transmit the retrieved related document records to the terminal device to augment construction of the prompt sentence.

10. The system according to claim 9, wherein the circuitry is configured to incorporate retrieved related document records into the prompt sentence by generating a reference clause set derived from the related document records, and encoding the reference clause set as additional context in the prompt sentence input to the generative neural network model.

11. The system according to claim 1, wherein the circuitry is configured to update the index database after each update to the electronic document data by re-extracting the purpose identifier, the party identifier, the period parameter, and the type identifier from the updated electronic document data, and updating the search information stored in the index database with the re-extracted values.

12. The system according to claim 1, wherein the circuitry is configured to generate a plurality of text output candidates by executing the generative neural network model with varied sampling parameters, score each candidate based on a structural completeness metric derived from the heading information and clause information, and select the highest-scoring candidate as the text output data.

13. The system according to claim 1, wherein the circuitry is configured to apply a retrieval-augmented generation architecture by querying a vector database using an embedding vector derived from the structured input data to retrieve reference documents, and incorporating the retrieved reference documents into the prompt sentence.

14. The system according to claim 1, wherein the circuitry is configured to calculate the emotion information by applying a regression model to the user input information to compute at least a valence score and an arousal score, and to select the tone parameter by mapping the valence score and the arousal score to a tone selection table stored in the storage device.

15. The system according to claim 14, wherein the circuitry is configured to generate an approval workflow follow-up notification sequence based on the emotion information, the approval workflow follow-up notification sequence comprising a plurality of notification events each associated with a timing parameter and a notification content template selected based on the tone parameter.

16. The system according to claim 1, wherein the circuitry is configured to apply a clause completeness check to the post-processed text output data by comparing extracted clause identifiers against a required clause set derived from the type identifier, and to regenerate missing clauses by constructing a targeted prompt sentence for input to the generative neural network model.

17. The system according to claim 1, wherein the circuitry is configured to monitor a response latency of the generative neural network model, and to switch between a full-parameter model and a distilled model based on whether the response latency exceeds a predefined latency threshold.

18. A system comprising:
circuitry configured to:
receive, via a communication interface coupled to a packet-switched network, structured input data from a terminal device;
apply a natural language processing model to the structured input data to extract a purpose identifier, a party identifier, a period parameter, and a type identifier;
construct a prompt sentence encoding the extracted identifiers and parameters, and input the prompt sentence to a generative neural network model to obtain text output data;
post-process the text output data by applying a structural parsing algorithm to assign heading information, clause information, and format information, and generate electronic document data conforming to a predetermined document file format;
store the electronic document data in a storage device and register the extracted identifiers and metadata in an index database;
execute emotion analysis processing on user input information to compute emotion information, and adjust at least one of a tone parameter or an expression strength parameter of the prompt sentence based on the emotion information; and
transmit the electronic document data and the adjusted prompt sentence parameters to the terminal device via the communication interface.

19. The system according to claim 18, wherein the circuitry is configured to apply an emotion identification model to the user input information to generate an emotional state vector, and to adjust a follow-up condition of an approval workflow based on the emotional state vector.

20. A method comprising:
receiving, via a communication interface coupled to a packet-switched network, structured input data from a terminal device, and extracting, by applying a natural language processing model to the structured input data, a purpose identifier, a party identifier, a period parameter, and a type identifier;
constructing a prompt sentence encoding the purpose identifier, the party identifier, the period parameter, and the type identifier, and inputting the prompt sentence and the structured input data to a generative neural network model to obtain text output data;
post-processing the text output data to assign heading information, clause information, and format information to segments of the text output data, and generating electronic document data conforming to a predetermined document file format based on the post-processed text output data;
storing the electronic document data in a storage device, and registering the purpose identifier, the party identifier, the period parameter, the type identifier, and metadata associated with the electronic document data as search information in an index database;
transmitting the electronic document data to the terminal device via the communication interface so that the electronic document data is displayable and editable at the terminal device;
executing emotion analysis processing on user input information received from the terminal device to calculate emotion information, and adjusting at least one of a tone parameter, an expression strength parameter, or a follow-up condition of the prompt sentence based on the emotion information; and
acquiring, from the terminal device, a correction instruction, re-inputting a corrected prompt sentence incorporating the correction instruction and at least a portion of the electronic document data into the generative neural network model to obtain updated text output data, and updating the electronic document data based on the updated text output data.
